(19) United States
(12) Patent Application Publication
(10) Pub. No.: US 2025/0047432 A1
(43) Pub. Date: Feb. 6, 2025

(54) TIME-DIVISION MULTIPLEXING OF SENSING AND COMMUNICATION SIGNALS

(71) Applicant: QUALCOMM Incorporated, San Diego, CA (US)

(72) Inventors: Hyojin LEE, San Diego, CA (US); Weimin DUAN, San Diego, CA (US); Yu ZHANG, San Diego, CA (US)

(21) Appl. No.: 18/363,643

(22) Filed: Aug. 1, 2023

(51) Int. Cl. H04L 5/00; H04W 72/0446

(52) U.S. Cl. CPC H04L 5/0048; H04W 72/0446

(57) ABSTRACT

Aspects of the disclosure involve a technique for receiving signals for communication and sensing. The technique comprises receiving, at a communication device, one or more sensing signals within an air interface frame structure comprising a plurality of slots, each slot comprising a plurality of symbols. The one or more sensing signals occupy a first subset symbols in the plurality of symbols. The technique further comprises receiving, at the communication device, one or more communication signals occupying a second subset of symbols in the plurality of symbols. The one or more sensing signals comprise one or more sensing waveforms, each being associated with a duration aligned with one or more symbol boundaries. The one or more communication signals comprise one or more communication symbols, each being associated with a duration aligned with one or more symbol boundaries.

### BACKGROUND

### 1. Field of Disclosure

The present disclosure relates generally to the field of radio frequency (RF) sensing, and more specifically joint operation of wireless communications and RF sensing.

### 2. Description of Related Art

RF sensing broadly refers to the reception and use of reflected and/or emitted radio frequency (RF) radiation to determine one or more physical characteristics within an environment. Various physical characteristics may be determined, such as an object's range (i.e., distance away from a reference point), direction, position (e.g., relative position with respect to one or more reference point or absolute position within a given three-dimensional space), speed, velocity, etc. Radio detection and ranging (radar) is a type of RF sensing technology that uses the reflection of radio waves (e.g., RF signals) to determine characteristics such as the distance (ranging), angle, and/or radial velocity of one or more objects.

Wireless communication systems typically involve the use of RF signals to communicate data between or among two or more points, without the use of a physical conductor, such as a wire or cable. For example, data can be modulated onto a carrier signal which can be wirelessly propagated over distances from one point to one or more other points. Examples of wireless communications include those that utilize one or more base stations (BS) and user equipment (UE) that communicate with the base station(s). A type of wireless communication system that is widely used is one that that is commonly referred to as a 5th Generation (5G) New Radio (NR) communication system based on a standard defined by the 3rd Generation Partnership Project (3GPP).

Joint communications and sensing (JCS) has been identified as a potential capability for future wireless communication networks. By employing existing nodes such as base stations (BS) and user equipment (UE), RF sensing can be implemented without adding significant additional costs and take advantage of existing coverage areas already established for wireless communications. However, the inclusion of sensing capabilities in wireless communication networks presents many challenges.

### BRIEF SUMMARY

Aspects of the disclosure involve the multiplexing of communications signals and sensing signals based on time-division multiplexing (TDM) while maintaining symbol-level alignment within an air interface frame structure. For example, one or more sensing signals, such as one or more frequency modulated continuous wave (FMCW) signals, may be transmitted during one or more sensing slots or sensing symbols, while one or more communication signals, such as one or more Orthogonal Frequency-Division Multiplexing (OFDM) signals, may be transmitted during one or more communication slots or communication symbols. The sensing slots, sensing symbols, communication slots, and/or communication symbols, may be aligned with time slots and symbols defined within the air interface frame structure. In some aspects, the timing of the one or more sensing signals and/or communication signals is organized with respect to the duration of a single slot. In other aspects, the timing of the one or more sensing signals and/or communication signals is organized with respect to the duration of multiple slots.

Aspects of the disclosure involve a technique for receiving signals for communication and sensing. The technique comprises receiving, at a communication device, one or more sensing signals within an air interface frame structure. The air interface frame structure comprises a plurality of slots, each slot comprising a plurality of symbols in a time domain. The air interface frame structure further comprises a plurality of carriers, each carrier comprising a plurality of subcarriers in a frequency domain. The one or more sensing signals occupy a first subset symbols in the plurality of symbols of the air interface frame structure. The technique further comprises receiving, at the communication device, one or more communication signals within the air interface frame structure. The one or more communication signals occupy a second subset of symbols in the plurality of symbols of the air interface frame structure. The one or more sensing signals comprise one or more sensing waveforms, each of the one or more sensing waveforms being associated with a sensing waveform symbol duration, the sensing waveform symbol duration being aligned with one or more symbol boundaries of the air interface frame structure. The one or more communication signals comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration.

Other aspects of the disclosure involve a technique for transmitting signals for communication and sensing. The technique comprises transmitting, from a communication device, one or more sensing signals within an air interface frame structure. The air interface frame structure comprises a plurality of slots, each slot comprising a plurality of symbols in a time domain. The air interface frame structure further comprises a plurality of carriers, each carrier comprising a plurality of subcarriers in a frequency domain. The one or more sensing signals occupy a first subset symbols in the plurality of symbols of the air interface frame structure. The technique further comprises transmitting, from the communication device, one or more communication signals within the air interface frame structure. The one or more communication signals occupy a second subset of symbols in the plurality of symbols of the air interface frame structure. The one or more sensing signals comprise one or more sensing waveforms, each of the one or more sensing waveforms being associated with a sensing waveform symbol duration, the sensing waveform symbol duration being aligned with one or more symbol boundaries of the air interface frame structure. The one or more communication signals comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration.

Some aspects of the disclosure involve a technique for operating a communication device for communication and sensing. The technique comprises receiving, at the communication device, one or more configuration parameters specifying one or more sensing signals within an air interface frame structure. The air interface frame structure comprises a plurality of slots, each slot comprising a plurality of symbols in a time domain. The air interface frame structure further comprises a plurality of carriers, each carrier comprising a plurality of subcarriers in a frequency domain. The one or more sensing signals occupy a first subset symbols in the plurality of symbols of the air interface frame structure. One or more communication signals occupy a second subset of symbols in the plurality of symbols of the air interface frame structure. The technique further comprises transmitting or receiving the one or more sensing signals in accordance with the one or more configuration parameters. The one or more sensing signals comprise one or more sensing waveforms, each of the one or more sensing waveforms being associated with a sensing waveform symbol duration, the sensing waveform symbol duration being aligned with one or more symbol boundaries of the air interface frame structure. The one or more communication signals comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration

Some aspects of the disclosure involve a device for receiving signals for communication and sensing. The device comprises one or more antennas, an analog-to-digital (A/D) converter coupled to the one or more antennas, one or more processors coupled to the A/D converter, and a memory coupled to the one or more processors. The one or more antennas may be configured to receive a radio frequency (RF) signal. The RF signal comprises (1) one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure, and (2) one or more communication signals within the air interface frame structure, wherein the one or more communication signals occupy a second subset of symbols in the plurality of symbols of the air interface frame structure. The one or more sensing signals comprise one or more sensing waveforms, each of the one or more sensing waveforms being associated with a sensing waveform symbol duration, the sensing waveform symbol duration being aligned with one or more symbol boundaries of the air interface frame structure. The one or more communication signals comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration. The A/D converter is configured to generate a digital signal based on the RF signal. The one or more processors are configured receive the digital signal to process the one or more sensing signals and the one or more communication signals.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a diagram showing an example of how beamforming may be performed, according to some embodiments.

FIG. 4 is a diagram showing an example of a frame structure for NR and associated terminology.

FIG. 5 illustrates a simplified diagram of a RADAR system incorporated as part of a communications device, according to one or more embodiments.

FIG. 6 is a frequency-versus-time plot of a frequency modulated continuous wave (FMCW) TX signal, exhibiting characteristic “chirps,” according to an embodiment of the disclosure.

FIG. 7 is a frequency-versus-time plot of a FMCW TX signal and a received, reflected version of the same signal (i.e., FMCW RX signal).

FIG. 8 is a representation of an example of 2D range and Doppler estimation based on the received FMCW signal.

FIG. 9 illustrates an example of 5th Generation (5G) New Radio (NR) OFDM Numerology.

FIG. 10 illustrates an example of the operational capabilities of a commercially available FMCW radar transceiver.

FIG. 11 illustrates an example call flow for an NR-based sensing procedure (e.g., a bistatic sensing procedure) in which the network configures the sensing parameters, according to aspects of the disclosure.

FIG. 12 illustrates a time-division multiplexing example in which the sensing waveform symbol duration (e.g., FMCW symbol length T_{FMCW}) is substantially equal to the communication symbol duration (e.g., OFDM symbol length T_{OFDM}), and the basic scheduling unit is a slot.

FIG. 13 illustrates another time-division multiplexing example in which the sensing waveform symbol duration (e.g., FMCW symbol length T_{FMCW}) is substantially equal to the communication symbol duration (e.g., OFDM symbol length T_{OFDM}), and the basic scheduling unit is a slot.

FIG. 14 illustrates an example of separately configurable component carrier (CC) bandwidths for sensing signals (e.g., FMCW signals) and communication signals (e.g., OFDM).

FIG. 15 illustrates a time-division multiplexing example in which the sensing waveform symbol duration (e.g., FMCW symbol length T_{FMCW}) is substantially equal to the communication symbol duration (e.g., OFDM symbol length T_{OFDM}), the guard period duration (e.g., T_{GP}) is comparable to the communication symbol duration, and the basic scheduling unit is a symbol.

FIGS. 16A and 16B illustrate the possible use of a third type of guard period to address frequency jumps in the sensing signal.

FIG. 17 illustrates a time-division multiplexing example in which the sensing waveform symbol duration (e.g., FMCW symbol length T_{FMCW}) is substantially equal to the communication symbol duration (e.g., OFDM symbol length T_{OFDM}), the guard period duration (e.g., T_{GP}) is less than the communication symbol duration, and the basic scheduling unit is a symbol.

FIG. 18A shows examples of one or more guard periods being defined as part of each sensing symbol.

FIG. 18B shows examples of no guard period being defined as part of each sensing symbol.

FIG. 19 illustrates a time-division multiplexing example in which the sensing waveform symbol duration (e.g., FMCW symbol length T_{FMCW}) is greater than or equal to the communication symbol duration (e.g., OFDM symbol length T_{OFDM}), the guard period duration (e.g., T_{GP}) is also greater than or equal to the communication symbol duration, and the basic scheduling unit is a symbol.

FIG. 20 illustrates a time-division multiplexing example in which the sensing waveform symbol duration (e.g., FMCW symbol length T_{FMCW}) is greater than or equal to the communication symbol duration (e.g., OFDM symbol length T_{OFDM}), the guard period duration (e.g., T_{GP}) is greater than or equal to the communication symbol duration, and the basic scheduling unit is a symbol, with transmission of joint communication and sensing signals spanning multiple slots.

FIG. 21 illustrates a time-division multiplexing example in which the sensing waveform symbol duration (e.g., FMCW symbol length T_{FMCW}) is greater than or equal to the communication symbol duration (e.g., OFDM symbol length T_{OFDM}), the guard period duration (e.g., T_{GP}) is less than the communication symbol duration, and the basic scheduling unit is a symbol.

FIG. 22 illustrates a time-division multiplexing example in which the sensing waveform symbol duration (e.g., FMCW symbol length T_{FMCW}) is greater than or equal to the communication symbol duration (e.g., OFDM symbol length T_{OFDM}), the guard period duration (e.g., T_{GP}) is less than the communication symbol duration, and the basic scheduling unit is a symbol, with transmission of joint communication and sensing signals spanning multiple slots.

FIG. 23 presents a portion of a communication device implementing transmission of time-division multiplexed (TDM) joint communication and sensing (JCS) signals using a single set of hardware for generating both FMCW and OFDM signals, according to some embodiments of the disclosure.

FIG. 24 presents a portion of a communication device implementing transmission of TDM multiplexed JCS signals using one set of hardware for generating FMCW signals and another set of hardware for generating OFDM signals, according to some embodiments of the disclosure.

FIG. 25 presents a portion of a communication device implementing reception of TDM multiplexed JCS signals using a single set of hardware for processing of both FMCW and OFDM signals, according to some embodiments of the disclosure.

FIG. 26 presents a portion of a communication device implementing reception of TDM multiplexed JCS signals using one set of hardware for processing of FMCW signals and another set of hardware for processing OFDM signals, according to some embodiments of the disclosure.

FIG. 27 is a flow diagram of a method of receiving signals for communication and sensing, according to an embodiment.

FIG. 28 is a flow diagram of a method of transmitting signals for communication and sensing, according to an embodiment.

FIG. 29 is a flow diagram of a method of operating a communication device for communication and sensing, according to an embodiment.

FIG. 30 is a block diagram of an embodiment of a UE, which can be utilized in embodiments as described herein.

FIG. 31 is a block diagram of an embodiment of a base station, which can be utilized in embodiments as described herein.

FIG. 32 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

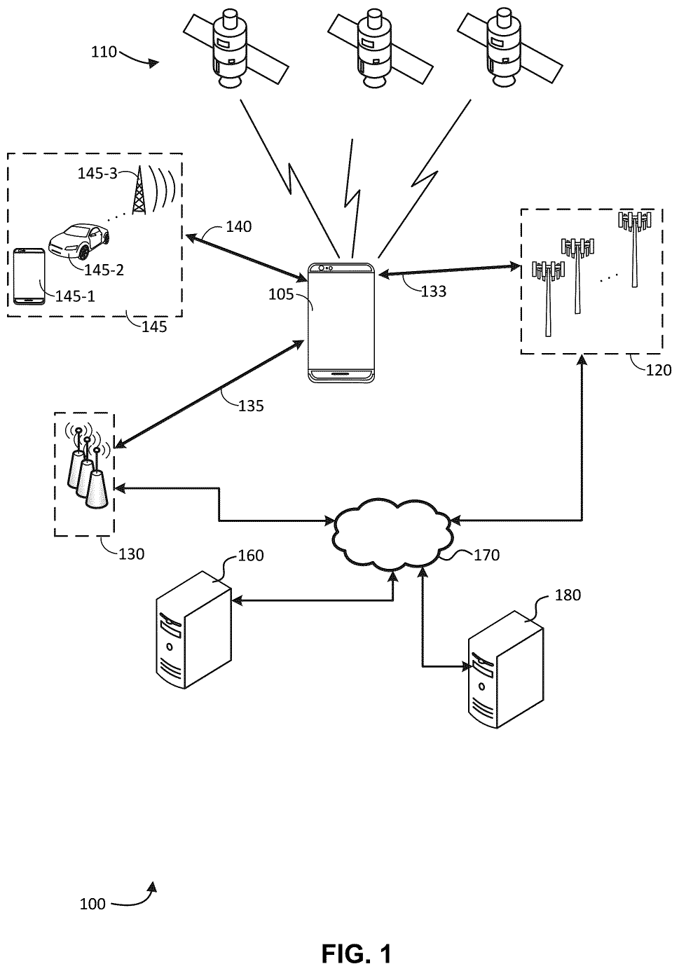

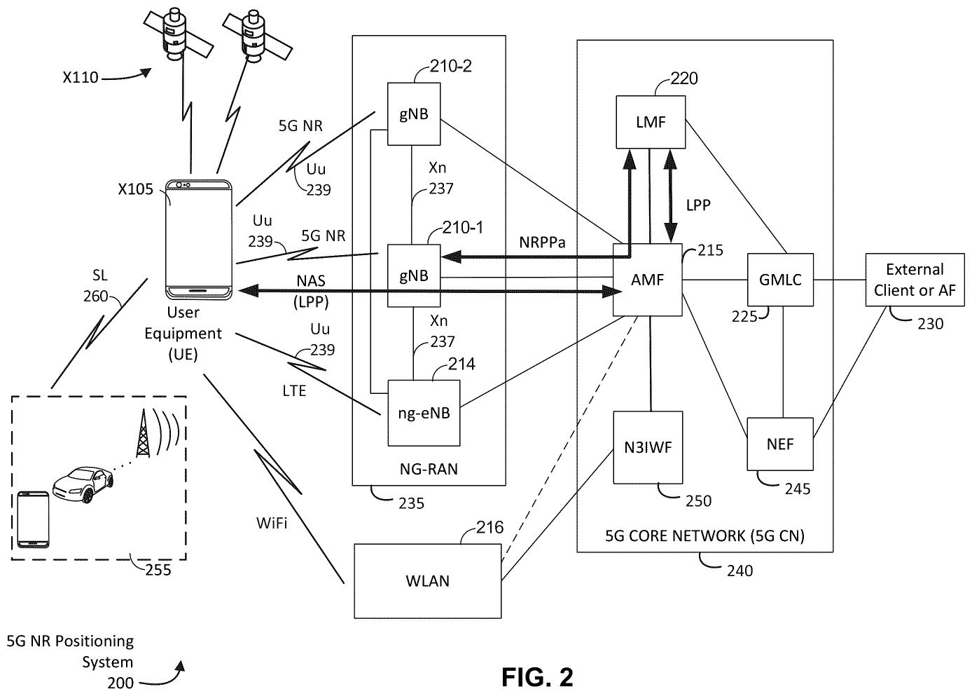

FIG. 1 is a simplified illustration of a positioning system 100 in which a UE 105, location server 160, and/or other components of the positioning system 100 can use the techniques provided herein for joint communication and sensing using resource elements, according to an embodiment. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220, described in more detail hereafter.

Positioning of the UE 205 in a 5G NR positioning system 200 further may utilize measurements between the UE 205 and one or more other UEs 255 via a sidelink connection SL 260. As shown in FIG. 2, the one or more other UEs 255 may comprise any of a variety of different device types, including mobile phones, vehicles, roadside units (RSUs), other device types, or any combination thereof. One or more position measurement signals sent via SL 260 to the UE 205 from the one or more other UEs 255, to the one or more other UEs 255 from the UE 205, or both. Various signals may be used for position measurement, including sidelink PRS (SL-PRS). In some instances, the position of at least one of the one or more of the other UEs 255 may be determined at the same time (e.g., in the same positioning session) as the position of the UE 205. In some embodiments, the LMF 220 may coordinate the transmission of positioning signals via SL 260 between the UE 205 and the one or more other UEs 255. Additionally or alternatively, the UE 205 and the one or more other UEs 255 may coordinate a positioning session between themselves, without an LMF 220 or even a Uu connection 239 to an access node of the NG-RAN 235. To do so, the UE 205 and the one or more other UEs 255 may communicate messages via the SL 260 using sidelink positioning protocol (SLPP). In some scenarios, the one or more other UEs 255 may have a Uu connection 239 with an access node of the NG-RAN 235 and/or Wi-Fi connection with WLAN 216 when the UE 205 does not. In such instances, the one or more other UEs 255 may operate as relay devices, relaying communications to the network (e.g., LMF 220) from the UE 205. In such instances, a plurality of other UEs 255 may form a chain between the UE 205 and the access node.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

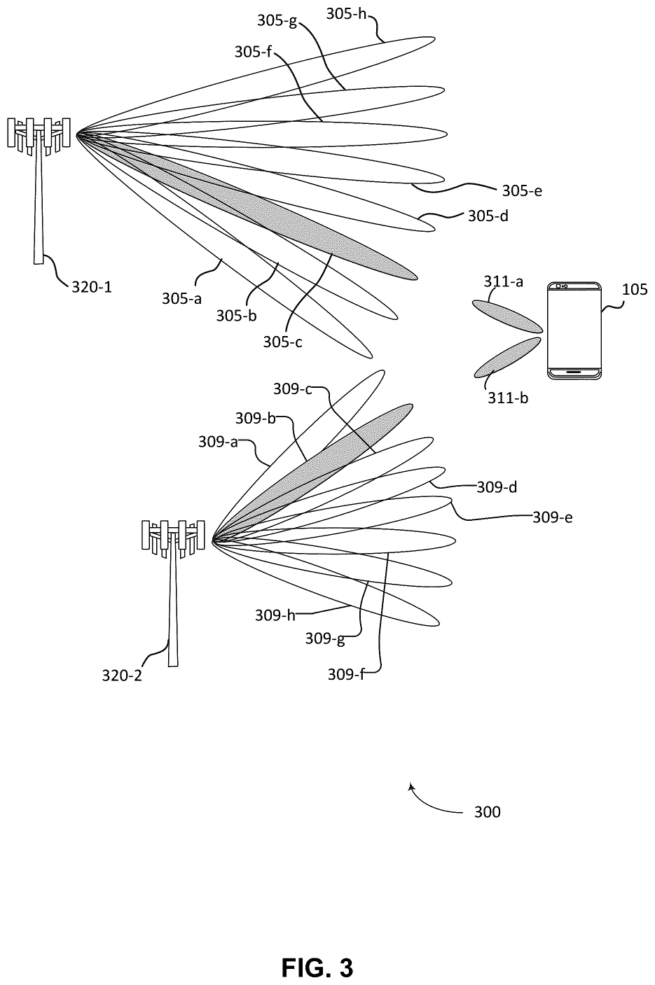

FIG. 3 is a diagram illustrating a simplified environment 300 including two base stations 320-1 and 320-2 (which may correspond to base stations 120 of FIG. 1 and/or gNBs 210 and/or ng-eNB 214 of FIG. 2) with antenna arrays that can perform beamforming to produce directional beams for transmitting and/or receiving RF signals. FIG. 3 also illustrates a UE 105, which may also use beamforming for transmitting and/or receiving RF signals. Such directional beams are used in 5G NR wireless communication networks. Each directional beam may have a beam width centered in a different direction, enabling different beams of a base station 320 to correspond with different areas within a coverage area for the base station 320.

Different modes of operation may enable base stations 320-1 and 320-2 to use a larger or smaller number of beams. For example, in a first mode of operation, a base station 320 may use 16 beams, in which case each beam may have a relatively wide beam width. In a second mode of operation, a base station 320 may use 64 beams, in which case each beam may have a relatively narrow beam width. Depending on the capabilities of a base station 320, the base station may use any number of beams the base station 320 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a base station 320 may use beam sweeping. Beam sweeping is a process in which the base station 320 may send an RF signal in different directions using different respective beams, often in succession, effectively “sweeping” across a coverage area. For example, a base station 320 may sweep across 120 or 360 degrees in an azimuth direction, for each beam sweep, which may be periodically repeated. Each direction beam can include an RF reference signal (e.g., a PRS resource), where base station 320-1 produces a set of RF reference signals that includes Tx beams 305-a, 305-b, 305-c, 305-d, 305-e, 305-f, 305-g, and 305-h, and the base station 320-2 produces a set of RF reference signals that includes Tx beams 309-a, 309-b, 309-c, 309-d, 309-e, 309-f, 309-g, and 309-h. As noted, because UE 105 may also include an antenna array, it can receive RF reference signals transmitted by base stations 320-1 and 320-2 using beamforming to form respective receive beams (Rx beams) 311-a and 311-b. Beamforming in this manner (by base stations 320 and optionally by UEs 105) can be used to make communications more efficient. They can also be used for other purposes, including taking measurements for position determination (e.g., AoD and AoA measurements).

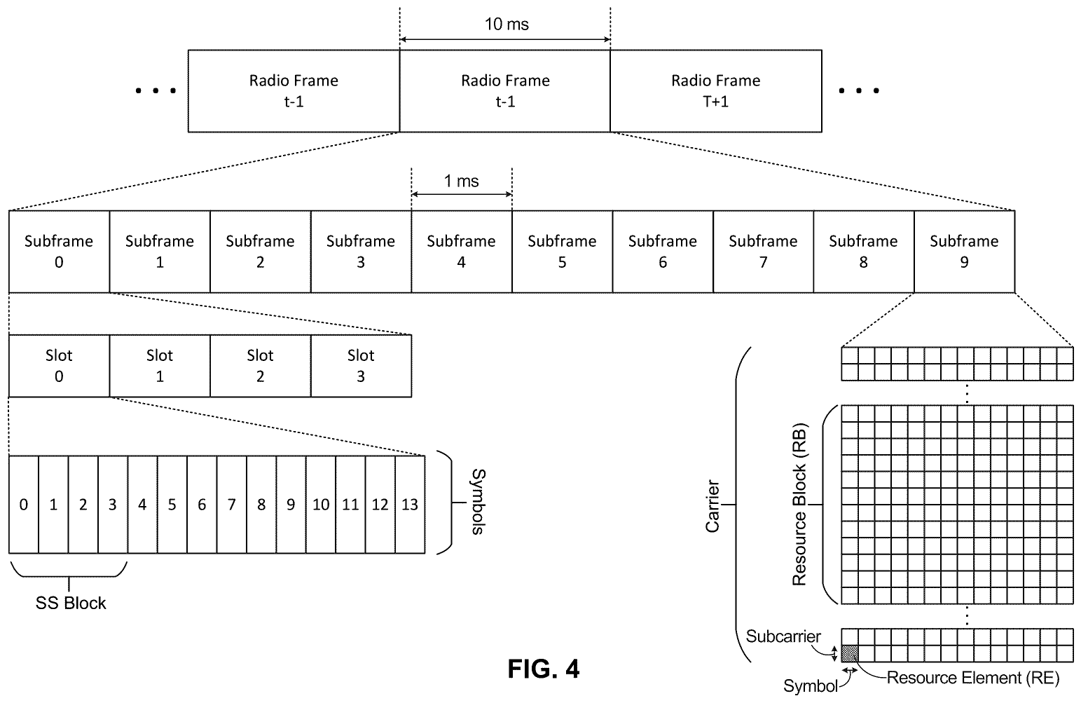

FIG. 4 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 4 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 4. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

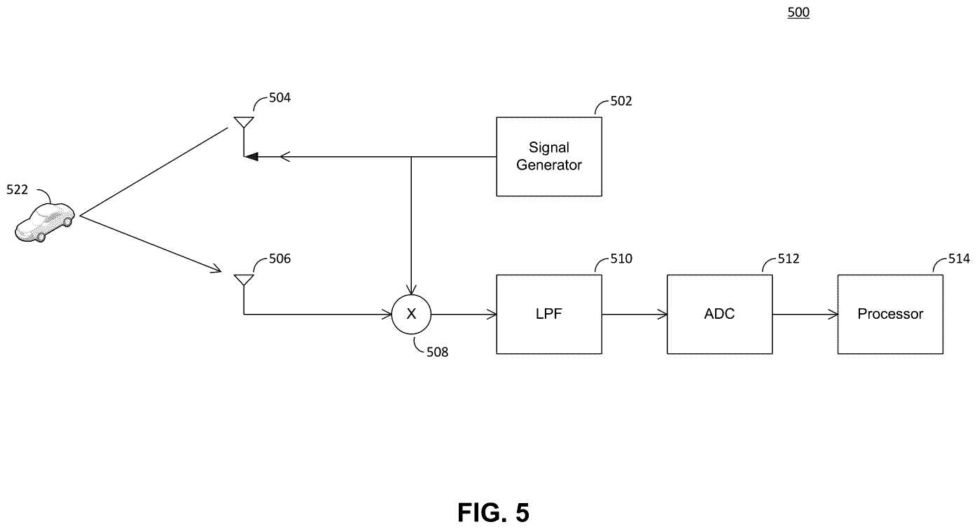

FIG. 5 illustrates a simplified diagram of an example of an RF sensing system, in the form of a RADAR system 500, incorporated as part of a communications device such as a base station or a UE according to one or more embodiments. The communications functionality (e.g., OFDM transmission and reception) is not explicitly shown, in order to highlight the RF sensing functionality presented in this figure. RADAR system 500 may operate to obtain range, direction of arrival (DoA), velocity, and/or other information pertaining to a target 522. In the embodiment shown in the figure, RADAR system 500 may comprise a signal generator 502, a transmit (TX) antenna 504, a receive (RX) antenna 506, a mixer 508, a low pass filter (LPF) 510, an analog-to-digital converter (ADC) 512, and a processor 514. While only one target 522 is shown for simplicity of illustration, it is contemplated that RADAR system 500 may obtain range, velocity, angle estimation, and/or other information pertaining to more than one target. Also, while a monostatic RADAR system is illustrated in this figure, a bi-static or multi-static RADAR system may also incorporate the features of the present disclosure.

Referring to FIG. 5, signal generator 502 generates a RADAR TX signal, which is provided to TX antenna 504. Transmit antenna 104 may transmit the RADAR TX signal toward target 522. The signal reflects off of one or more surfaces of target 522, and the reflected signal reaches RX antenna 506 after a time delay, which is proportional to the roundtrip distance between system 500 and target 522 as well as the speed of the signal, generally calculated as the speed of light, c. The received signal from RX antenna, often referred to as the radio frequency (RF) signal, is provided to one input of mixer 508. A local version of the RADAR TX signal is provided to another input of mixer 508. Mixer 508 performs a signal multiplication operation on (“mixes”) the two input signals and generates an output signal. In other words, the received RF signal, which has experienced the roundtrip delay, is mixed down using the local version of the same signal. Mixer 508 outputs the resulting mixed down signal, often referred to as the intermediate frequency (IF) signal. LPF 510, which may be characterized by a cutoff frequency, is then used to filter the IF signal, to generate a low pass-filtered signal. ADC 512 is then used to sample and digitize the low pass-filtered signal, to generate a digital signal that represents the IF signal. The digital signal is then provided to processor 514, which can perform further downstream processing to eventually generate information relating to target 522 such as range, velocity, and direction-of-arrival (DoA) estimations.

While not shown in this figure, RADAR system 500 may include more than one set of RX components, such as RX antennas, in order to perform angle-of-arrival estimation. For example, the collection of RX components comprising receive antenna 506, mixer 508, LPF 510, and ADC 512 may together form one RX processing chain. Multiple instances of such RX processing chain may be included in RADAR system 500 to generate multiple ADC outputs, which may be provided to processor 514, to facilitate DoA estimations.

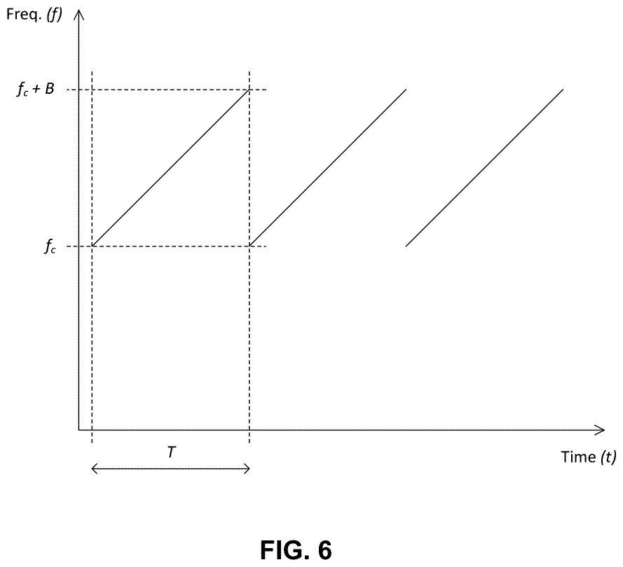

FIG. 6 is a frequency-versus-time plot of a frequency modulated continuous wave (FMCW) TX signal, exhibiting characteristic “chirps,” according to an embodiment of the disclosure. An FMCW waveform is a complex sinusoid whose frequency increases linearly with time. The frequency of the FMCW signal may be expressed as:

$${f}_{t} = {f}_{c} + ( \frac{B}{T} ) * t \qquad ( Eq . 1 )$$

where f_{c} is the carrier frequency, B is the signal bandwidth, and t∈[0,T]. The y-axis represents frequency amplitude, and the x-axis represents time. Each chirp is a continuous wave (e.g., sinusoidal) signal with an instantaneous frequency that changes over time, hence the name frequency-modulated, continuous wave signal. In this particular example, the frequency increases as a linear function of time. However, different types of frequency modulation are possible. Some examples of FMCW signals include “sawtooth” signals whose frequency linearly increases (or decreases) from a starting frequency to an ending frequency in each cycle, “triangular” signals whose frequency alternates between linearly increasing and linearly decreasing over each cycle to return to the starting frequency, “square-wave” or “step” signals whose frequency switches to different constant levels over each cycle, “sinusoidal” signals whose frequency changes as a sinusoidal function of time, etc. Also, while an FMCW signal is illustrated in this figure, the techniques presented in the present disclosure may be applicable to other types of RADAR TX signals, including other types of continuous wave (CW) signals, depending on the environment to be accommodated and the performance characteristics desired.

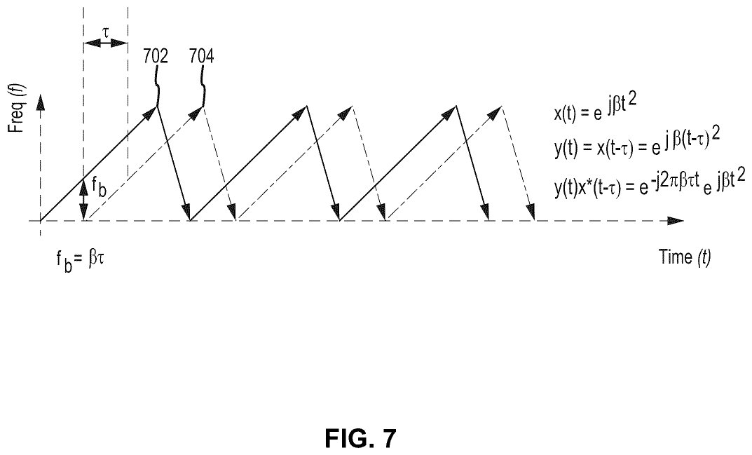

FIG. 7 is a frequency-versus-time plot of a FMCW TX signal 702 and a received, reflected version of the same signal (i.e., FMCW RX signal 704). Again, the y-axis represents frequency amplitude, and the x-axis represents time. The FMCW TX signal 702 may be expressed as:

$$x ( t ) = {e}^{j β {t}^{2}} \qquad ( Eq . 2 )$$

The FMCW RX signal 704 may be expressed as:

$$y ( t ) = x ( t - τ ) = {e}^{j {β ( t - τ )}^{2}} \qquad ( Eq . 3 )$$

Here, β represents the slope of the change in frequency over change in time of the FMCW waveform

$$( i . e . , β = \frac{Δ f}{Δ t} ) .$$

The time delay z represents the relative delay between the FMCW TX signal 302 and the FMCW RX signal 304.

The output of mixer 508 in FIG. 5 is the result of mixing the FMCW TX signal 702 and FMCW RX signal 704. This resulting signal may also be referred to as the IF signal, as discussed previously. The IF signal can be expressed as:

$$y ( t ) {x}^{*} ( t ) = {e}^{j 2 πβ τ t} {e}^{j {βτ}^{2}} \qquad ( Eq . 4 )$$

The IF signal may exhibit a “beat” frequency f_{b}=βτ. Typically, if the IF signal is sampled into a digitized format, a Fast Fourier Transform (FFT) may be performed on the IF signal to convert it into the frequency domain. This may be referred to as performing a “range transform.” Each peak in the output of the range transform may represent a “beat” frequency f_{b}. Note that the beat frequency, expressed as f_{b}=βτ, is directly related to the time delay τ between the FMCW TX signal 702 and the FMCW RX signal 704. Based on this relationship, the RADAR system 500 can use the range spectrum to detect the distance to the target, by determining the beat frequency f_{b}, then determining the time delay τ, and finally determining the roundtrip distance of the reflected path traveled by the signal (by taking into account the known propagation speed of the signal, e.g., the speed of light, c). There may be multiple beat frequencies f_{b} observed in the IF signal. Each beat frequency f_{b} may correspond to one or more potential targets located at the detected range (i.e., distance) indicated by the beat frequency. Thus, extracting the beat frequency f_{b} corresponds to performing the “range” estimate on the received RADAR signal.

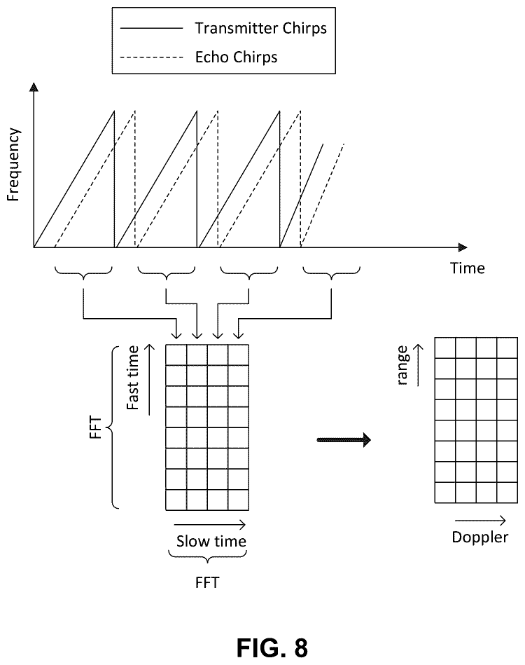

FIG. 8 is a representation of an example of 2D range and Doppler estimation based on the received FMCW signal. As illustrated in FIG. 5, the process of obtaining the beat signal is implemented in the radio frequency domain by a mixer (e.g., mixer 508), followed by a bandpass or lowpass filter (e.g., LPF 510). The beat signal frequency equals f_{b}=f_{R}+f_{D}, where f_{R}=2*R*B/(T*c) is the range frequency and f_{D}=(2ν/c)*f_{c} is the Doppler frequency. Here, R is the target range, c is the speed of light and v is the radial speed of the target. The estimation of the beat frequency could be implemented in the digital domain through 2-D FFT. It holds that (2*Rₘₐₓ/c)<<T, and thus f_{R}<<B (Rₘₐₓ is the maximum detected range). Also, it typically holds that f_{D}<<f_{R}. Hence the beat frequency is much smaller than signal bandwidth B. Therefore, a low-speed (and therefore low-cost) ADC can be used to sample the beat signal. For example, a low-cost may have a sampling frequency in the hundreds (100s) of MHz to ten (10) or tens (10s) of MHz.

FIG. 8 shows how the result of mixing the transmitted chirps with the corresponding reflected (echo) chirps can be processed digitally to generate range, velocity, and potentially spatial information regarding one or more targets. The result of mixing the echo chirp with the transmitted chirp is obtained in digital form from the ADC and stored in a frame structure. The time during one period or chirp is usually referred to as the “fast time,” while the time across multiple periods chirps is referred to as the “slow time.” Specifically, an FFT performed on sampled data from the mixer for a chirp results in a range-FFT. Each range-FFT is thus arranged along the “fast-time” axis. In most use cases, f_{D} can be treated as constant within each chirp. Hence the FFTs on the beat signal along the fast time can identify the range frequency f_{R} and the corresponding target's range R=c*f_{R}*T/(2B).

Along a second dimension, A Doppler-FFT can performed across range-FFTs for different chirps to obtain an estimate of the velocity of the target(s). A second FFT operation along the slow time (assuming the range frequency f_{R} is the same across the slow time) could obtain the target's Doppler. Each Doppler-FFT is thus arranged along the slow-time axis. The range-FFTs and Doppler-FFTs form a two-dimensional (2D) FFT result. Along a third dimensions, a spatial-FFT can be performed across a stack of 2D FFTs obtained from different versions of the signal received at spatially distinct positions (e.g., multiple antennas) to obtain an estimate of the angle-of-arrival (AoA) of the target(s). Taking the spatial-FFT along the third dimension generates a 3D FFT structure (not explicitly shown) that is also referred to as a 3D FFT cube.

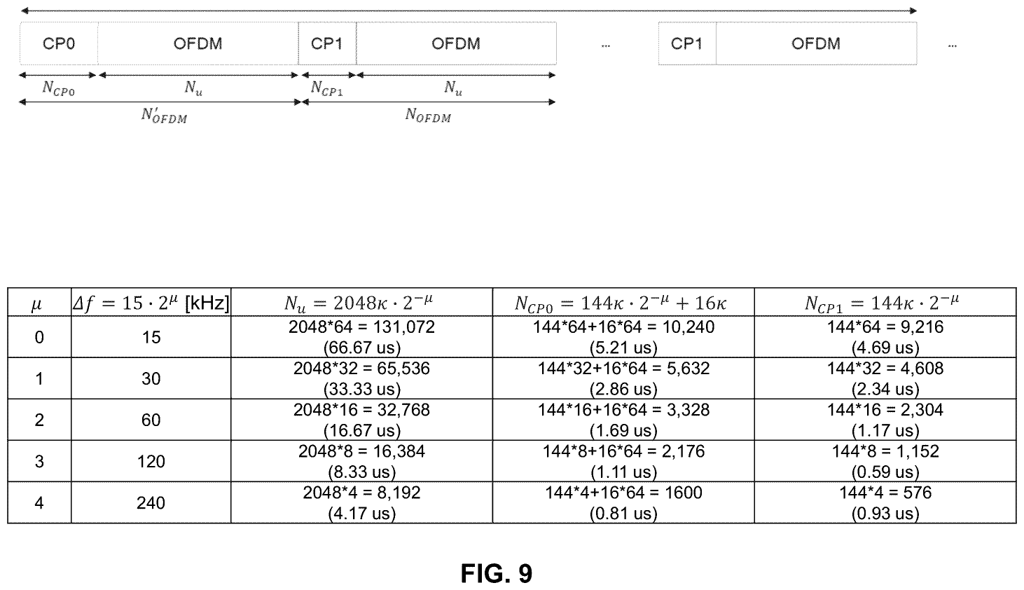

FIG. 9 illustrates an example of 5th Generation (5G) New Radio (NR) OFDM Numerology. Multiplexing of RF sensing signals with signals for communications, e.g., FMCW and OFDM signals, takes into account the timing and frequency structures of the two types of signals. The NR OFDM numerology presented in the present figure shows particular timing characteristics of an OFDM signal with a cyclic prefix (CP) portions positioned before each OFDM portion in time. The cyclic prefix portions including an initial cyclic prefix portion C0 and one or more subsequent cyclic prefix portions CP1. In this NR numerology example, the chip period is defined as Tc=1/(Δfₘₐₓ*N_{f})=0.59 nanosecond (ns), where the maximum subcarrier spacing Δfₘₐₓ=480 KHz, with N_{f}=4096, and k=64.

The duration (in time) of each OFDM portion and cyclic prefix portion may be defined in units of number of chips (N). The symbol length N_{OFDM} (in chips) corresponds to T_{OFDM} (in time) equals to 0.5 milliseconds (ms) in this case. The duration of the OFDM portion may be expressed as Nᵤ. The duration of the CP0 cyclic prefix portion may be expressed as N_{CP0}. The duration of the CP1 cyclic prefix portion may be expressed as N_{CP1}. As can be seen, the first cyclic prefix portion CP0 has a longer duration than each of the subsequent cyclic prefixes CP1, which have the same duration as one another.

For different values of subcarrier spacing Δf, the figure presents the durations of the OFDM portion (Nᵤ), C0 cyclic prefix (NCP0), C1 cyclic prefix (NCP1), The durations are expressed in terms of number of chips as well as time. As can be seen, a transmitter capable of operating at the different subcarrier spacing values shown would support a range of symbol lengths T_{OFDM}, e.g., 71.35 us, 35.68 us, 17.40 us, 8.92 us, and 4.46 us.

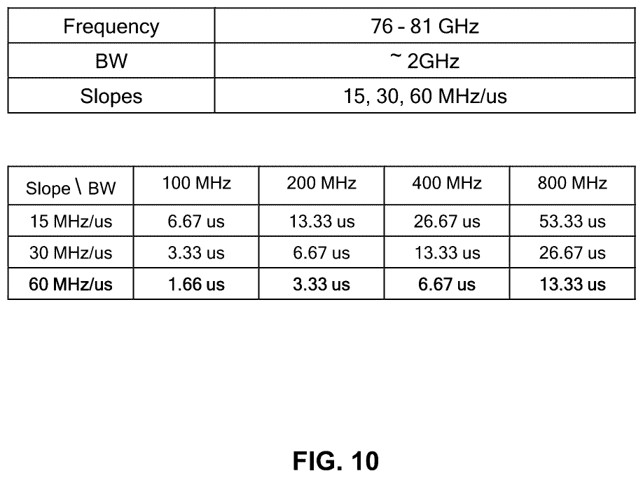

FIG. 10 illustrates an example of the operational capabilities of a commercially available FMCW radar transceiver. This particular FMCW transceiver is capable of operating in the RF frequencies of 76-81 GHz and supports various possible slopes (e.g., 15 MHz/us, 30 MHz/us, and 60 MHz/us) of the linearly increasing FMCW waveform for different possible bandwidths (e.g. 100 MHz, 200 MHz, 400 MHz, and 800 MHz). The figure shows the FMCW waveform duration T_{FMCW} for the different combinations of slope and bandwidth. As can be seen, for this particular FMCW radar transceiver, the FMCW waveform duration T_{FMCW} may range from 1.66 us to 53.33 us.

If joint communications and sensing is implemented using the NR OFDM numerology shown in FIG. 9 and the FMCW radar transceiver shown in FIG. 10, different possible scenarios of symbol lengths T_{OFDM} v. FMCW waveform duration T_{FMCW} may emerge. The OFDM symbol length T_{OFDM} ranges from 4.46 us to 71.35 us, and FMCW symbol length T_{FMCW} ranges from 53.33 us to 1.66 us. Thus, the OFDM symbol length T_{OFDM}, in this example, can range from ˜1/10 T_{FMCW} to ˜60 T_{FMCW}. In other words, various scenarios can occur, including: T_{FMCW}<T_{OFDM}, T_{FMCW}≈T_{OFDM}, and T_{FMCW}>T_{OFDM}. Some embodiments of the disclosure specifically address scenarios of the FMCW symbol length T_{FMCW} being substantially equal to or greater than the OFDM symbol length T_{OFDM}.

Furthermore, embodiments of the disclosure implement a unified joint communications and sensing waveform to support a wide variation of uses. The different uses include uplink (UL)-based monostatic, bi-static, and multi-static sensing operations, as well as downlink (DL)-based monostatic, bi-static, and multi-static sensing operations. The different uses also include the re-use of the sending waveform (e.g., FMCW) for communication purposes, such as channel estimation and beam management. The different uses further include time-division multiplexing (TDM) of RF sensing signals (e.g., FMCW) and communications and/or reference signals (e.g., OFDM). Just as an example, a communication device implementing an aspect of the disclosure may comprise a base station, and the FMCW signal and the plurality of OFDM signals may form a downlink transmission from the base station. As another example, a communication device implementing an aspect of the disclosure may comprise a UE, and the FMCW signal and the plurality of OFDM signals may form an uplink transmission from the UE.

In certain embodiments, a time-division multiplexing (TDM) of RF sensing (e.g., FMCW) and OFDM signals may be implemented using analog, digital, or a mix of analog and digital components. For example, analog components may be used on the transmitter side, in the form of a voltage-controlled oscillator (VCO) operated to generate an analog FMCW transmit signal with time-varying frequency (e.g., frequency linearly increasing as a function of time). On the receiver side, the received FMCW signal can be mixed with the transmitted wideband FMCW signal (or a version of the transmitted FMCW signal in the case of bi-static or multi-static sensing) in analog form, before being sampled by a D/A converter. Because the signal being sampled has already been “mixed down,” the sampling rate of the D/A converter can be relatively low. Given that the cost of a D/A converter depends largely on its sampling rate (lower sampling rate corresponding to lower cost), mixing the received signal in analog form allows the cost of the receiver to be significantly lowered. As such, an analog, wideband FMCW transceiver represents a cost-effective option, especially for transmitting and receiving FMCW signals for UEs.

As another example, on the base station side, both the FMCW signal and the OFDM signal can be generated in digital form and converted to analog form for transmission using the same hardware components, e.g., same D/A converter. For instance, in the case of DL bistatic sensing, the UE may have the option to generate a wide bandwidth FMCW signal in the analog domain (e.g., using a VCO-based implementation) to reduce the cost for wideband sensing. In such a scenario, the UE may still implement regular or small bandwidth baseband system for data communications (e.g., OFDM signals). For UL based sensing, if RF sensing and communications are implemented as TDM multiplexed signals, the UE may generate a wideband FMCW transmission signal with a VCO-based implementation. In yet another example, if the RF sensing bandwidth and the communications bandwidth supported by UE are the same or close in magnitude, the UE may implement one set of hardware that is shared between RF sensing and communication. Even in such a scenario, there may still be use cases (SL or UL-based UE-to-UE bistatic sensing) in which UE may still implement an analog FMCW transmitter using a VCO, separately from the OFDM transmitter.

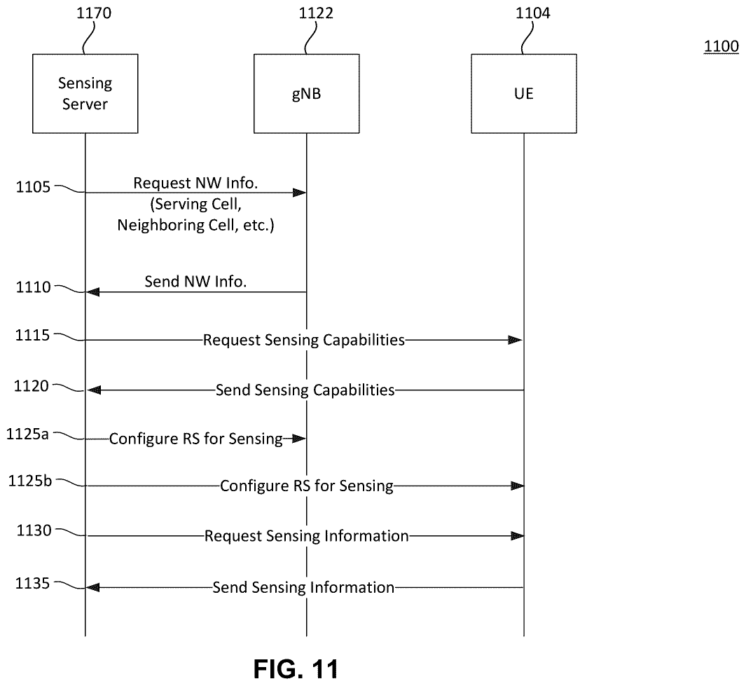

FIG. 11 illustrates an example call flow 1100 for an NR-based sensing procedure (e.g., a bistatic sensing procedure) in which the network configures reference signals, e.g., to support time-division multiplexing (TDM) of sensing signals and communication signals, according to some aspects of the disclosure. In this example, the sensing server 1170 is shown as being implemented separately from the gNB 1122 and the UE 1104. In other embodiments, the sending server may be implemented as part of a gNB or as part of a UE. Although FIG. 11 illustrates a network-coordinated sensing procedure, the sensing procedure could be coordinated over sidelink channels. At stage 1105, a sensing server 1170 (e.g., inside or outside the core network) sends a request for network (NW) information to a gNB 1122 (e.g., the serving gNB of a UE 1104). The request may be for a list of the UE's 1104 serving cell and any neighboring cells. At stage 1110, the gNB 1122 sends the requested information to the sensing server 1170. At stage 1115, the sensing server 1170 sends a request for sensing capabilities to the UE 1104. At stage 1120, the UE 1104 provides its sensing capabilities to the sensing server 1170. At stage 1125a, the sensing server 1170 sends a configuration to the gNB 1122 indicating the reference signals (RS) that will be transmitted for sensing. At stage 1125b, the sensing server 1170 sends a configuration to the UE 1104 indicating the reference signals (RS) that will be transmitted for sensing.

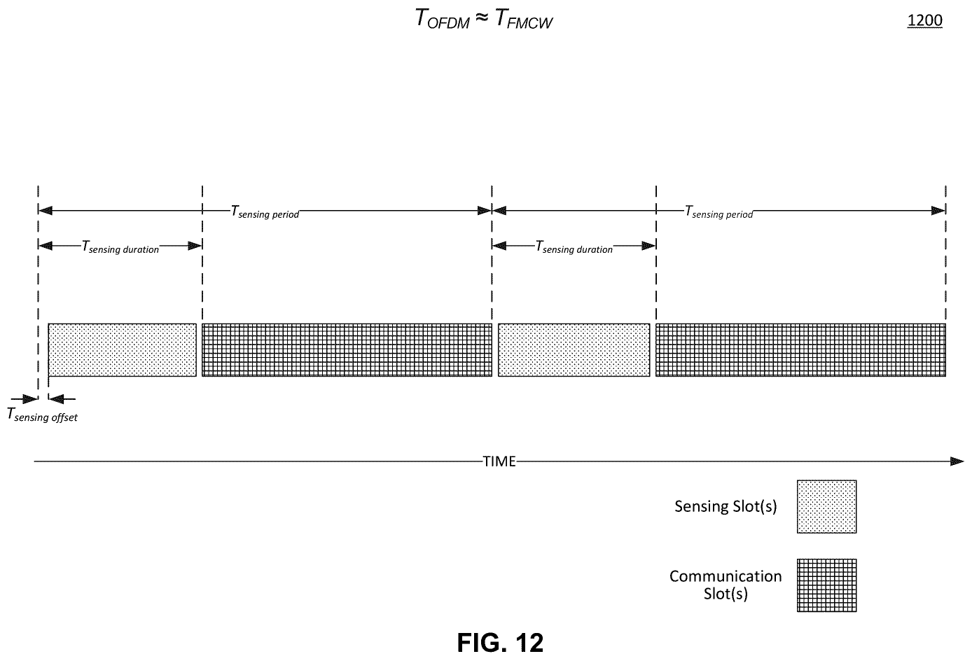

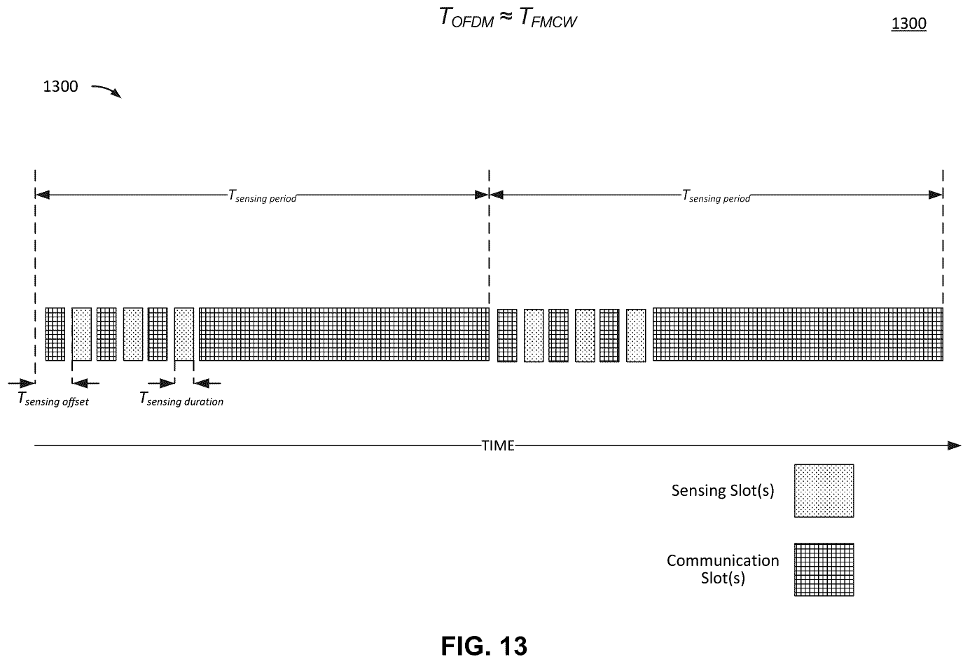

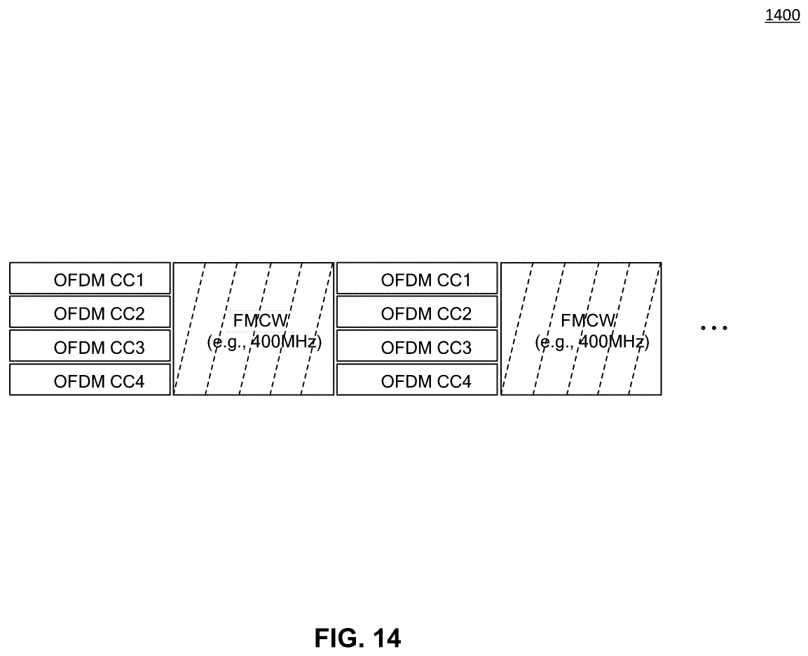

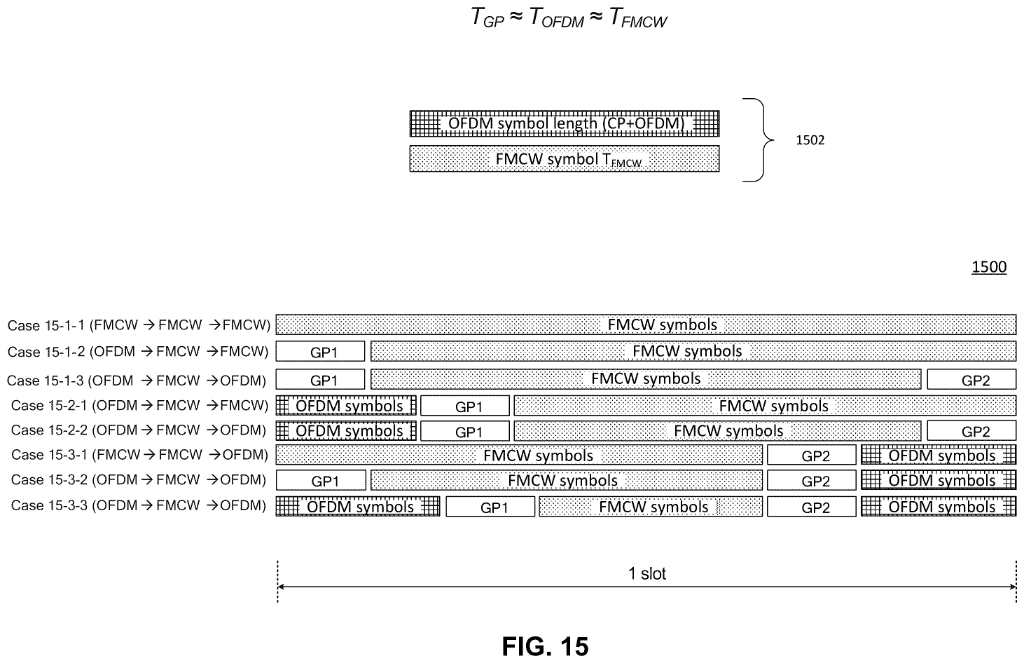

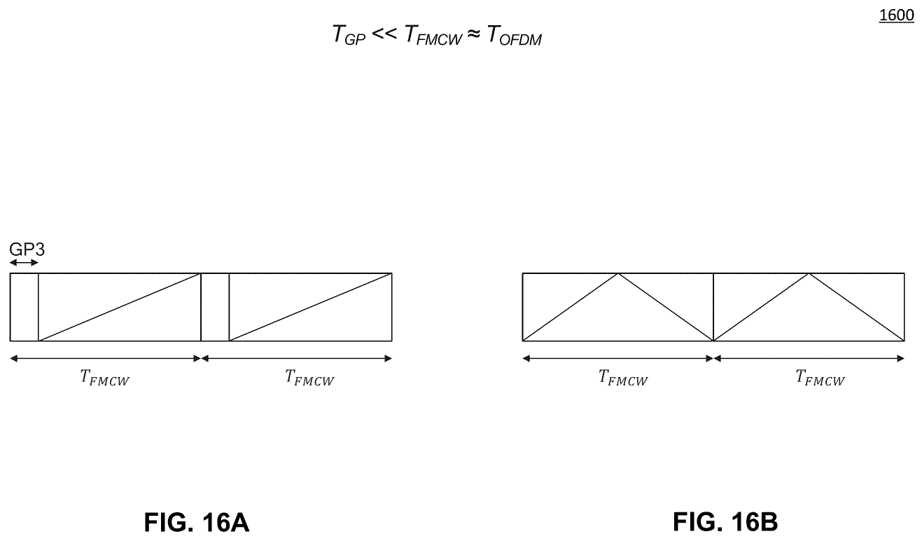

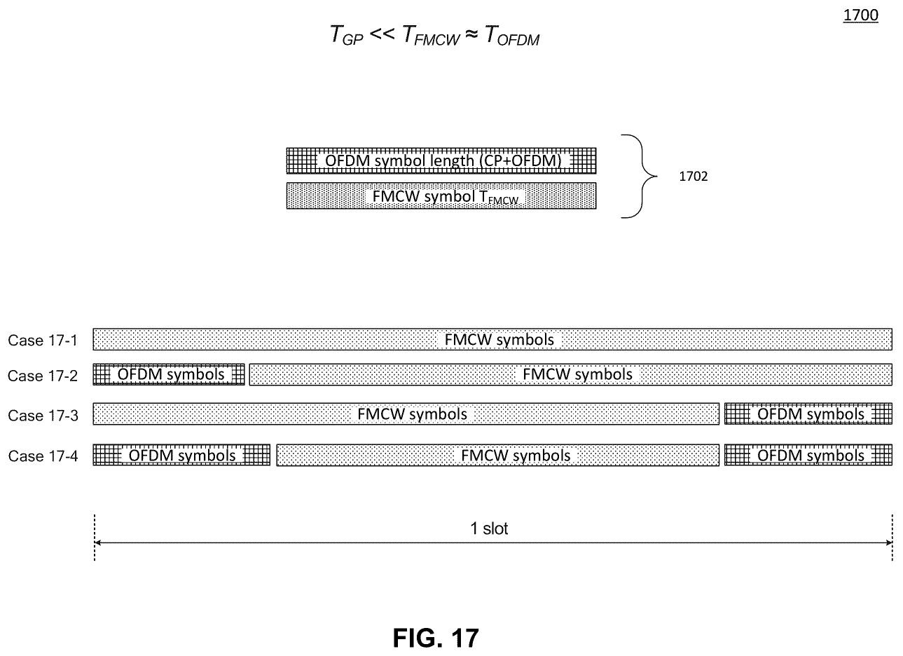

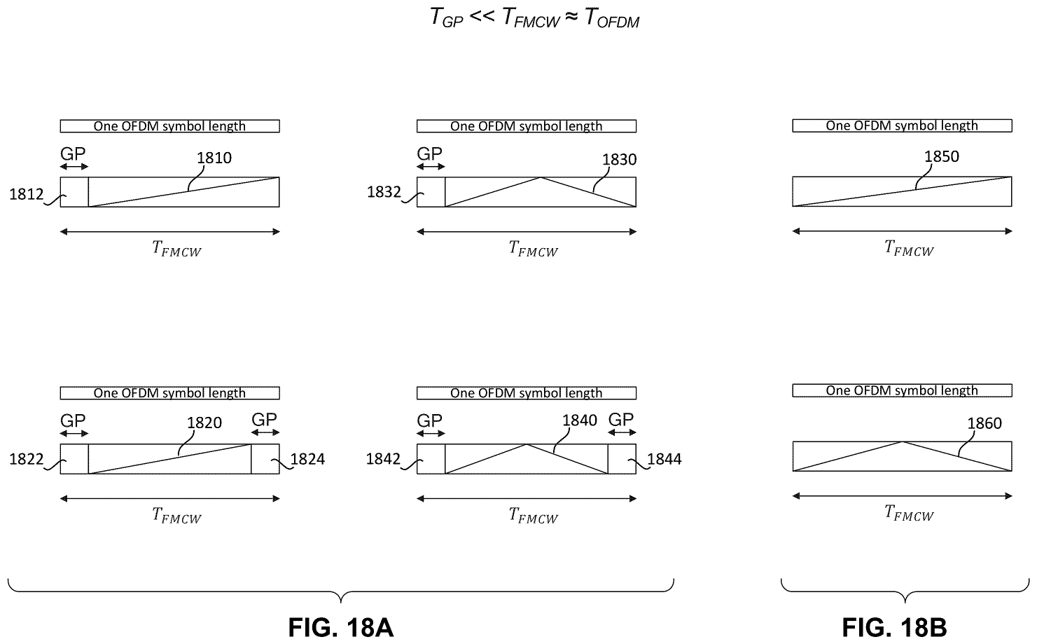

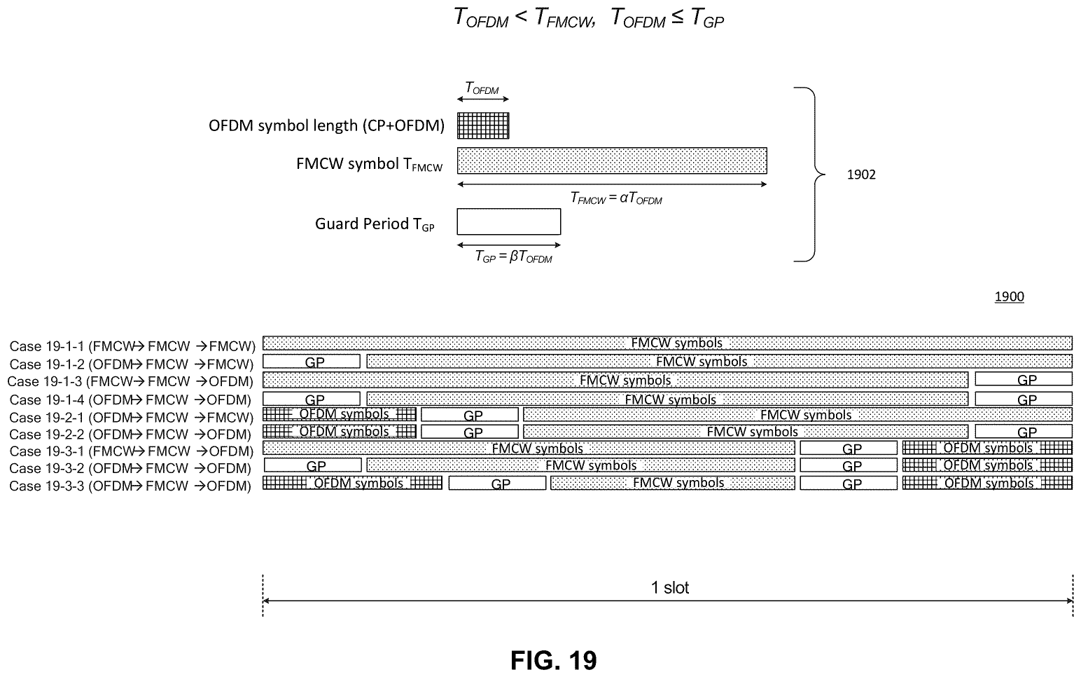

The RS configuration sent by the sensing server 1170 to the gNB 1122 and/or the UE 1104 may include, various configuration parameters discussed herein that support time-division multiplexing (TDM) of sensing signals and communication signals. Examples of such sensing configuration parameters include:
Parameters that specify a periodic schedule for the transmission of sensing and/or communication signals, e.g., (1) a sensing offset parameter, (2) a sensing period parameter, (3) a sensing duration parameter, (4) a number of repetitions parameter, (5) a gap between repetitions parameter, and (6) a sensing repetition offset parameter, as discussed in later sections such as FIGS. 12 and 13
Parameters that specify the bandwidth(s) allocated to sensing signals and/or communication signals, e.g., component carrier (CC) bandwidths or bandwidth parts (BWPs), as discussed in later sections such as FIG. 14
Parameters that specify the position of any FMCW symbols and/or guard periods (GPs) that replace communication symbols in a slot structure, as discussed in later sections such as FIGS. 15, and 17
Parameters that specify the existence, the position, and/or the length of any guard periods (GPs) as part of a sensing symbol, e.g., as discussed in later section such as FIGS. 16A, 16B, 18A and 18B
Parameters that specify the duration of sensing symbols, communication symbols, and/or guard periods in a slot structure (e.g., a, p, M_{F}, and M₀) discussed in later section such as FIGS. 19-22

Returning to FIG. 11, the reference signals for sensing may be transmitted by the serving and/or neighboring cells identified at stage 1110, based on the sensing configuration parameters provided by the sending server ______. At stage 1130, the sensing server 1170 sends a request for sensing information to the UE 1104. The UE 1104 then measures the transmitted reference signals and, at stage 1135, sends the measurements, or any sensing results determined from the measurements, to the sensing server 1170.

While in the above example, the sensing signals (e.g., reference signals) are transmitted by the gNB and received by the UE in a bi-static radar operation, other techniques described herein may be applied to other scenarios. For example, either a gNB or a UE may serve as the communication device sending the reference signals or the communication device receiving the reference signals. For instance, the UE may transit the reference signals, and the gNB may receive the reference signals in a bi-static radar operation. In a monostatic radar operation, the UE (or the gNB) may transmit and receive the reference signals.

In an aspect, the communication between the UE 1104 and the sensing server 1170 may be via the LTE positioning protocol (LPP). The communication between the sensing server 1170 and the gNB may be via NR positioning protocol type A (NRPPa).

FIG. 12 illustrates a time-division multiplexing example 1200 in which the sensing waveform symbol duration (e.g., FMCW symbol length T_{FMCW}) is substantially equal to the communication symbol duration (e.g., OFDM symbol length T_{OFDM}), and the basic scheduling unit is a slot. According to some embodiments, a communication device supports transmitting or receiving one or more consecutive communication symbols and/or one or more consecutive sensing symbols using different slots. Because the basic scheduling unit is a slot, the sensing symbols and communication symbols are positioned such that symbol boundaries are aligned and each slot boundary is inherently maintained. As discussed previously, e.g., in the context of FIG. 4, an air interface frame structure may comprise a plurality of slots, each slot comprising a plurality of symbols in a time domain. The interface frame structure may further comprise a plurality of carriers, each carrier comprising a plurality of subcarriers in a frequency domain. Example 1200 time multiplexes the transmission of sensing signals and communication signals based on a periodic schedule. Each of one or more sensing signals spans one or more sensing slots comprising a first subset of the plurality of slots of the air interface frame structure. Each of one or more communication signals spans one or more communication slots comprising a second subset of the plurality of slots of the air interface frame structure. In example 1200, the periodic schedule is defined using at least (1) a sensing offset parameter, (2) a sensing period parameter, and (3) a sensing duration parameter. These parameters define a periodic schedule in which a first group of contiguous slots may be designated as sensing slots, and a second group of continuous slots may be designated as communication slots. The sensing period parameter specifies the duration of each period. The sensing offset parameter specifies the offset between the start of the period and the start of the first group of contiguous slots (e.g., sensing slots). The sensing duration parameter specifies the duration of each of the first group of contiguous slots (e.g., sensing slots). The remaining slots in the period may be designated as the second group of continuous slots (e.g., communication slots). The sending offset parameter, sensing period parameter, and the sending duration parameter may each be expressed in units of number of slots. The period, thus defined, is repeated to construct the periodic schedule.

FIG. 13 illustrates another time-division multiplexing example 1300 in which the sensing waveform symbol duration (e.g., FMCW symbol length T_{FMCW}) is substantially equal to the communication symbol duration (e.g., OFDM symbol length T_{OFDM}), and the basic scheduling unit is a slot. According to some embodiments, a communication device supports transmitting or receiving one or more consecutive communication symbols and/or one or more consecutive sensing symbols using different slots. Again, because the basic scheduling unit is a slot, the sensing symbols and communication symbols are positioned such that symbol boundaries are aligned and each slot boundary is maintained. Similar to example 1200 shown in FIG. 12, example 1300 time multiplexes the transmission of sensing signals and communication signals based on a periodic schedule, in which sensing signals span a first subset of slots, and communication signals span a second subset of slots in an air interface frame structure. Here, the periodic schedule is defined using at least (1) a sensing offset parameter, (2) a sensing period parameter, (3) a sensing duration parameter, (4) a number of repetitions parameter, (5) a gap between repetitions parameter, and (6) a sensing repetition offset parameter. The parameters again define a periodic schedule in which a first group of contiguous slots may be designated as sensing slots, and a second group of continuous slots may be designated as communication slots.

However, example 1300 provides a more refined periodic structure, in which a secondary repetition pattern is defined within each period. The sensing period parameter specifies the duration of each period. The sensing offset parameter specifies the offset between the start of the period and the start of the secondary repetition pattern. The sensing repetition offset parameter specifies the offset between the start of the secondary repetition pattern and the start of the first group of continuous slots (e.g., sensing slots). The sensing duration parameter specifies the duration of each of the first group of contiguous slots (e.g., sensing slots). The number of repetitions parameter specifies the number of groups of contiguous slots that constitute the sensing slots (e.g., 3 groups of sensing slots) in the secondary repetition pattern. The gap between repetitions parameter specifies the gap, or amount of separation, between two successive groups of contiguous slots that constitute the sensing slots. Within a period, the secondary repetition pattern may define an alternating pattern of a group of sensing slots, followed by a group of communication slots, followed by a group of sensing slots, and so on, for a specified number of sensing slot groups. The secondary pattern may thus begin at some offset after the start of the period and end prior to the end of the period. The remaining slots in the period after the secondary pattern ends may be designated as communication slots. The sending offset parameter, sensing period parameter, the sending duration parameter, number of repetitions parameter, gap between repetitions parameter, and sensing repetition offset parameter may each be expressed in units of number of slots. The period, thus defined, is repeated to construct the periodic schedule.

In other embodiments, sensing slots may be scheduled aperiodically. For example, the one or more sensing slots and the one or more communication slots may be defined based on an aperiodic schedule within the air interface frame structure. In some designs, an aperiodic sensing slot may be dynamically indicated, for example, by designating one or more slots as a sensing slot(s) (e.g., having FMCW symbols) using a Downlink Control Information (DCI) message via a Physical Downlink Control Channel (PDCCH). In some designs, the aperiodic indication may include ON-OFF information or time-domain resource information (when to have the sensing slot). In some designs, some aperiodic parameters (such as slot structure) may be configured by higher layer signaling (e.g., Radio Resource Control (RRC) or Layer 3 (L3)) before triggering at a lower layer (e.g., DCI/Layer 1 (L1) or Medium Access Control (MAC)/Layer 2 (L2)).

According to some embodiments, one or more sensing slots are configurable between (1) an activated state in which the one or more sensing slots are used for sensing signals and (2) a deactivated state in which the one or more sensing slots are used for communication signals. For example, in some designs as noted above, the set of sensing slots may be scheduled semi-persistently. In some designs, such semi-persistent sensing slots may be activated/deactivated with similar parameters to periodic sensing slots, such as those as depicted in FIGS. 12 and 13.

FIG. 14 illustrates an example of separately configurable component carrier (CC) bandwidths for sensing signals (e.g., FMCW signals) and communication signals (e.g., OFDM). According to some embodiments, one or more sensing signals occupy one or more sensing signal bandwidths, and one or more communication signals occupy one or more communication signal bandwidths. The one or more sensing signal bandwidths at least partially overlap the one or more communication signal bandwidths. The one or more sensing signal bandwidths and the one or more communication signal bandwidths may be separately configurable.

For example, component carrier (CC) bandwidths can be separately configured for FMCW symbols and OFDM symbols. As discussed, the hardware required for processing a received FMCW signal may not require a large baseband bandwidth due to the fact that, after mixing with a version of the transmit FMCW signal (“beat” signal processing), the resulting baseband FMCW signal may have a relatively narrow bandwidth (as compared to the RF FMCW signal). Also, as discussed, there are existing FMCW transceivers that support large RF FMCW bandwidths (e.g., 2 GHz). A UE may report its (1) bandwidth capabilities for sensing (e.g., FMCW waveform) and (2) bandwidth capabilities for communication (e.g., OFDM waveform) to a sensing server or gNB. In response, the sensing server or gNB may configure the UE with separate bandwidths for sensing and communication. The reporting of capabilities from the UE and the configuration of the UE by the sensing server or gNB may be accomplished, for example, by an NR-based sensing procedure such as that discussed previously in the context of FIG. 11. In one specific example shown in FIG. 14, a UE is configured with four 100 MHz, CC bandwidths for OFDM signals, resulting in a frequency block of 400 MHz. The UE is separately configured with one CC bandwidth for FMCW signals, which also results in a frequency block of 400 Hz. That is, the four 100-MHz OFDM CC bandwidths occupy the same bandwidth/frequency block as the one 400-MHz FMCW CC bandwidth. While CC bandwidths are discussed in this example, other types of bandwidths, such as bandwidth parts (BWPs) may also be separately configured for sensing and communication signals in a similar fashion.

FIG. 15 illustrates a time-division multiplexing example 1500 in which the sensing waveform symbol duration (e.g., FMCW symbol length T_{FMCW}) is substantially equal to the communication symbol duration (e.g., OFDM symbol length T_{OFDM}), the guard period duration (e.g., T_{GP}) is comparable to the communication symbol duration, and the basic scheduling unit is a symbol. According to some embodiments, a communication device supports transmitting or receiving one or more consecutive communication symbols and/or one or more consecutive sensing symbols during a slot. Here, the sensing symbols and communication symbols are positioned such that symbol boundaries are aligned and each slot boundary is maintained. According to some embodiments, a communication device supports transmitting or receiving one or more consecutive communication symbols and/or one or more consecutive sensing symbols during a slot. As shown in illustration 1502 (time scale different from example 1500), the OFDM symbol length T_{OFDM} is equal to the FMCW symbol length T_{FMCW} in this example. A guard period (GP) may be used in the slot to separate a group of consecutive communication symbols from a group of consecutive sensing symbols. The guard period duration is comparable to the OFDM symbol duration. For example, the guard period duration T_{GP} may be equal to a number (e.g., several) times the duration of a OFDM symbol T_{OFDM}. Thus, a number of OFDM symbols in the slot can be replaced by a guard period, e.g., to allow time for receive hardware to switch between OFDM and FMCW signals. The length of the GP may be configured by the sensing server (e.g., implemented within the gNB or separately from the gNB) based on the UE capability reported, for example, by an NR-based sensing procedure such as that discussed previously in the context of FIG. 11. Other OFDM symbols may be replaced by FMCW symbols.

The configuration of a slot may be specified by identifying the location of FMCW symbols within the slot. In some embodiments, a communication device (e.g., UE) may receive a first slot configuration parameter specifying a number of consecutive sensing symbols and a second slot configuration parameter specifying a starting sensing symbol. Such slot configuration parameters may establish the location of the sensing symbols (e.g., FMCW symbols) within the slot. Guard periods may be inserted to separate the sensing symbols from communication symbols.

The scheme shown in example 1500 supports (1) a first type of transition occurring during the slot, from a transmission of one or more consecutive communication symbols to a transmission of one or more consecutive sensing symbols and (2) a second type of transition occurring during the slot, from a transmission of one or more consecutive sensing symbols to a transmission of one or more consecutive communication symbols. A first guard period (GP1) of the one or more guard periods is associated with the first type of transition and is positioned to separate the transmission of the one or more consecutive communication signals and the transmission of the one or more consecutive sensing signals. A second guard period (GP2) of the one or more guard periods is associated with the second type of transition and is positioned to separate the transmission of the one or more consecutive sensing signals and the transmission of the one or more consecutive communication signals.

Given the constraints described above, the resulting slot may belong to one of a number of different slot configuration types, including:
a first slot configuration type (15-1-1), corresponding to a transmission of one or more consecutive sensing symbols occupying an entire duration of the slot,
a second slot configuration type (15-1-2), corresponding to an instance of the first guard period, followed by a transmission of one or more consecutive sensing symbols,
a third slot configuration type (15-1-3), corresponding to an instance of the first guard period, followed by a transmission of one or more consecutive sensing symbols, followed by an instance of the second guard period,
a fourth slot configuration type (15-2-1), corresponding to a transmission of one or more consecutive communication symbols, followed by an instance of the first guard period, followed by a transmission of one or more consecutive sensing symbols,
a fifth slot configuration type (15-2-2), corresponding to a transmission of one or more consecutive communication symbols, followed by an instance of the first guard period, followed by a transmission of one or more consecutive sensing symbols, followed by an instance of the second guard period,
a sixth slot configuration type (15-3-1), corresponding to a transmission of one or more consecutive sensing symbols, followed by an instance of the second guard period, followed by a transmission of one or more consecutive communication symbols,
a seventh slot configuration type (15-3-2), corresponding to an instance of the first guard period, followed by a transmission of one or more consecutive sensing symbols, followed by an instance of the second guard period, followed by a transmission of one or more consecutive communication symbols, and
an eighth slot configuration type (15-3-3), corresponding to a transmission of one or more consecutive communication symbols, followed by an instance of the first guard period, followed by a transmission of one or more consecutive sensing symbols, followed by an instance of the second guard period, followed by a transmission of one or more consecutive communication symbols.

FIGS. 16A and 16B illustrate the possible use of a third type of guard period to address frequency jumps in the sensing signal. In addition to the first type of guard period (GP1) and the second type of guard period (GP2), the technique may further support a third type of guard period (GP3) to address frequency jumps within the sensing signal (e.g., from one FMCW symbol to the next FMCW symbol). For example, FIG. 16A shows a sawtooth FMCW signal. Each sawtooth FMCW waveform starts at a starting frequency (e.g., minimum frequency) and ends at an ending frequency (i.e., maximum frequency). A frequency jump is associated with the transition from the ending frequency of one FMCW waveform to the staring frequency of the next FMCW waveform. A third guard period (GP3) may be introduced that separates the two FMCW waveforms, to allow the receive hardware to adapt to the frequency jump. The third guard period (GP3) may be defined as part of each sensing symbol duration, e.g., FMCW symbol length T_{FMCW}. By contrast, FIG. 16B shows a triangular FMCW signal. Each triangular FMCW waveform, in this example, starts at a starting frequency (e.g., minimum frequency) and ends at an ending frequency that is the same as the starting frequency (i.e., minimum frequency). As such, there is no frequency jump associated with the transition from the end frequency of one FMCW waveform to the starting frequency of the next FMCW waveform. Accordingly, no third guard period (GP3) is introduced to provide time for frequency adaptation within the sensing signal, at least in some embodiments of the disclosure.

FIG. 17 illustrates a time-division multiplexing example 1700 in which the sensing waveform symbol duration (e.g., FMCW symbol length T_{FMCW}) is substantially equal to the communication symbol duration (e.g., OFDM symbol length T_{OFDM}), the guard period duration (e.g., T_{GP}) is less than the communication symbol duration, and the basic scheduling unit is a symbol. In some embodiments, a communication device supports transmitting or receiving one or more consecutive communication symbols and/or one or more consecutive sensing symbols during a slot. As shown in illustration 1702 (time scale different from example 1700), the OFDM symbol length T_{OFDM} is equal to the FMCW symbol length T_{FMCW} in this example. Again, the sensing symbols and communication symbols are positioned such that symbol boundaries are aligned and each slot boundary is maintained. The guard period duration T_{GP} is not capable of being expressed as a number (e.g., several) times the OFDM symbol length T_{OFDM}. Indeed, in some instances, the guard period duration T_{GP} is markedly less than the OFDM symbol length T_{OFDM}. A number of OFDM symbols in the slot can be replaced by an equal number of FMCW symbols. A guard period (GP) may be defined as part of each FMCW symbol.

Given the constraints described above, the resulting slot may belong to one of a number of different slot configuration types, including:
a first slot configuration type (17-1), corresponding to a transmission of one or more consecutive sensing symbols occupying an entire duration of the slot,
a second configuration type (17-2), corresponding to a transmission of one or more consecutive communication symbols, followed by a transmission of one or more consecutive sensing symbols,
a third slot configuration type (17-3), corresponding to a transmission of one or more consecutive sensing symbols, followed by a transmission of one or more consecutive communication symbols, and
a fourth slot configuration type (17-4), corresponding to a transmission of one or more consecutive communication symbols, followed by a transmission of one or more consecutive sensing symbols, followed by a transmission of one or more consecutive communication symbols.

FIG. 18A shows examples of one or more guard periods being defined as part of each sensing symbol. Such a configuration may be adopted in a scenario in which the sensing waveform symbol duration (e.g., FMCW symbol length T_{FMCW}) is substantially equal to the communication symbol duration (e.g., OFDM symbol length T_{OFDM}), and the guard period duration (e.g., T_{GP}) is less than the communication symbol duration, according to some embodiments of the disclosure. One or more guard periods are defined, as part of the duration of each sensing symbol, to separate the transmissions of one or more consecutive communication symbols and one or more consecutive sensing symbols. For each sensing symbol, a guard period (GP) may be defined before the sensing waveform, after the sensing waveform, or both before the sensing waveform and after the sensing waveform. The GP(s) and the sensing waveform together are defined within the duration of one communication symbol length (e.g., FMCW symbol length T_{FMCW}). A communication device (e.g., a UE or gNB) may be capable of transmitting and/or receiving such a sensing symbol, depending on the role of the communication device (e.g., as the sender, receiver, or both sender and receiver of the sensing signal, such as in monostatic or bi-static operations). A sensing server (e.g., as implemented within a gNB, within a UE, or separately from a gNB or UE), may provide configuration parameter(s) to the communication device to specify the existence, the position, and/or the length of the GP(s).

The specific examples show in FIG. 18A include an FMCW symbol comprising a sawtooth FMCW sensing waveform 1810 and a GP 1812 defined before the sawtooth FMCW waveform 1810. The entire FMCW symbol has a duration equal to one OFDM symbol length. Another example is an FMCW symbol comprising a sawtooth FMCW sensing waveform 1820, a first GP 1822 defined before the sawtooth FMCW waveform 1820, and a second GP 1824 defined after the sawtooth FMCW waveform 1820. The entire FMCW symbol has a duration equal to one OFDM symbol length. Another example is an FMCW symbol comprising a triangular FMCW sensing waveform 1830 and a GP 1832 defined before the triangular FMCW waveform 1830. The entire FMCW symbol has a duration equal to one OFDM symbol length. Yet another example is an FMCW symbol comprising a triangular FMCW sensing waveform 1840, a first GP 1842 defined before the triangular FMCW waveform 1840, and a second GP 1844 defined after the triangular FMCW waveform 1840. Once again, the entire FMCW symbol has a duration equal to one OFDM symbol length.

FIG. 18B shows examples of no guard period being defined as part of each sensing symbol. One example is an FMCW symbol comprising a sawtooth FMCW waveform 1850 with no GP defined as part of the FMCW symbol. The entire FMCW symbol has a duration of one OFDM symbol length. Another example is an FMCW symbol comprising a triangular FMCW waveform 1860 with no GP defined as part of the FMCW symbol. Again, the entire FMCW symbol has a duration of one OFDM symbol length. Here, any frequency adaptation at the transition between FMCW symbols and OFDM symbols may be performed by the communication device receiving the joint communication and sensing signals. A communication device (e.g., a UE or gNB) may be capable of transmitting and/or receiving such a sensing symbol, depending on the role of the communication device (e.g., as the sender, receiver, or both sender and receiver of the sensing signal, such as in monostatic or bi-static operations). For example, an implementation of the communication device may discard a first portion of the received FMCW symbol, to avoid distortions in the received signal associated frequency adaptation being performed by the receive hardware. A sensing server (e.g., as implemented within a gNB, within a UE, or separately from a gNB or UE), may provide configuration parameter(s) to the communication device to specify that no GP is defined as part of each FMCW symbol.

FIG. 19 illustrates a time-division multiplexing example 1900 in which the sensing waveform symbol duration (e.g., FMCW symbol length T_{FMCW}) is greater than to the communication symbol duration (e.g., OFDM symbol length T_{OFDM}), the guard period duration (e.g., T_{GP}) is greater than or equal to the communication symbol duration, and the basic scheduling unit is a symbol. In some embodiments, a communication device supports transmitting or receiving one or more consecutive communication symbols and/or one or more consecutive sensing symbols during a slot. Here, the sensing symbols and communication symbols are positioned such that symbol boundaries are aligned and each slot boundary is maintained.

Possible slot configurations according these embodiments may be characterized as follows. When Nₛₗₒₜ is the number of OFDM symbols in a slot (e.g., 14 symbols), the joint communication and sensing system supports scenarios in which T_{FMCW}=aT_{OFDM}, where a is an integer divisor of Nₛₗₒₜ. As shown in illustration 1902 (time scale different from example 1900), the FMCW symbol length T_{FMCW} is equal to a times the OFDM symbol length T_{OFDM}. The guard period duration T_{GP} is β times the OFDM symbol length T_{OFDM}. Here, α and β are positive integers equal to or greater than 1. The communication device may transmit or receive M₀ consecutive communication symbols and M_{F} consecutive sensing symbols over a slot. M₀ and M_{F} are positive integers equal to or greater than 0. A sensing server may configure the communication device, e.g., by sending one or more configuration parameters, to specify (α, β, M_{F}, M₀) and one of the slot configuration types described below.

Thus, when M₀ OFDM symbols and M_{F} FMCW symbols are transmitted, one of the following equations is satisfied:

$${aM}_{F} = {N}_{slot} , or \qquad ( case 19 - 1 - 1 )$$

$${aM}_{F} + b = {N}_{slot} , or {aM}_{F} + 2 b = {N}_{slot} \qquad ( case 19 - 1 - 2 and 19 - 1 - 3 )$$

$${M}_{0} + {aM}_{F} + b = {N}_{slot} \qquad ( case 19 - 2 - 1 and case 19 - 3 - 1 )$$

$${M}_{0} + {aM}_{F} + 2 b = {N}_{slot} \qquad ( case 19 - 2 - 2 , case 19 - 3 - 2 , and case 19 - 3 - 3 )$$

For example, when Nₛₗₒₜ=14 (NR), one or more of the following cases may be supported:

$$( α , β , {M}_{F} , {M}_{0} ) = ( 2 , 0 , 7 , 0 )$$

$$( α , β , {M}_{F} , {M}_{0} ) = ( 2 , 1 , {M}_{F} , 14 - 2 {M}_{F} - 1 ) or \\ ( 2 , 1 , 14 - 2 {M}_{F} - 2 ) where {M}_{F} = 1 , 2 , … , 6$$

$$( α , β , {M}_{F} , {M}_{0} ) = ( 2 , 2 , {M}_{F} , 14 - 2 {M}_{F} - 2 ) where \\ {M}_{F} = 1 , 2 , … , 6 or ( 2 , 2 , 14 - 2 {M}_{F} - 4 ) where {M}_{F} = 1 , 2 , … , 5$$

$$( α , β , {M}_{F} , {M}_{0} ) = ( 2 , 6 , {M}_{F} , 14 - 2 {M}_{F} - 6 ) where \\ {M}_{F} = 1 , 2 , … , 4 or ( 2 , 2 , 14 - 2 M\_F - 12 ) where {M}_{F} = 1$$

Given the constraints described above, the resulting slot may belong to one of a number of different slot configuration types, including:
a first slot configuration type (19-1-1), corresponding to a transmission of one or more consecutive sensing symbols occupying an entire duration of the slot,
a second slot configuration type (19-1-2), corresponding to a guard period, followed by a transmission of one or more consecutive sensing symbols,
a third slot configuration type (19-1-3), corresponding to a transmission of one or more consecutive sensing symbols, followed by a guard period,
a fourth slot configuration type (19-1-4), corresponding to a first guard period, followed by a transmission of one or more consecutive sensing symbols, followed by a second guard period,
a fifth slot configuration type (19-2-1), corresponding to a transmission of one or more consecutive communication symbols, followed by a guard period, followed by a transmission of one or more consecutive sensing symbols,
a sixth slot configuration type (19-2-2), corresponding to a transmission of one or more consecutive communication symbols, followed by a first guard period, followed by a transmission of one or more consecutive sensing symbols, followed by a second guard period,
a seventh slot configuration type (19-3-1), corresponding to a transmission of one or more consecutive sensing symbols, followed by a guard period, followed by a transmission of one or more consecutive communication symbols,
an eighth slot configuration type (19-3-2), corresponding to a first guard period, followed by a transmission of one or more consecutive sensing symbols, followed by a second guard period, followed by a transmission of one or more consecutive communication symbols, and
a ninth slot configuration type (19-3-3), corresponding to a transmission of one or more consecutive communication symbols, followed by a first guard period, followed by a transmission of one or more consecutive sensing symbols, followed by a second guard period, followed by a transmission of one or more consecutive communication symbols.

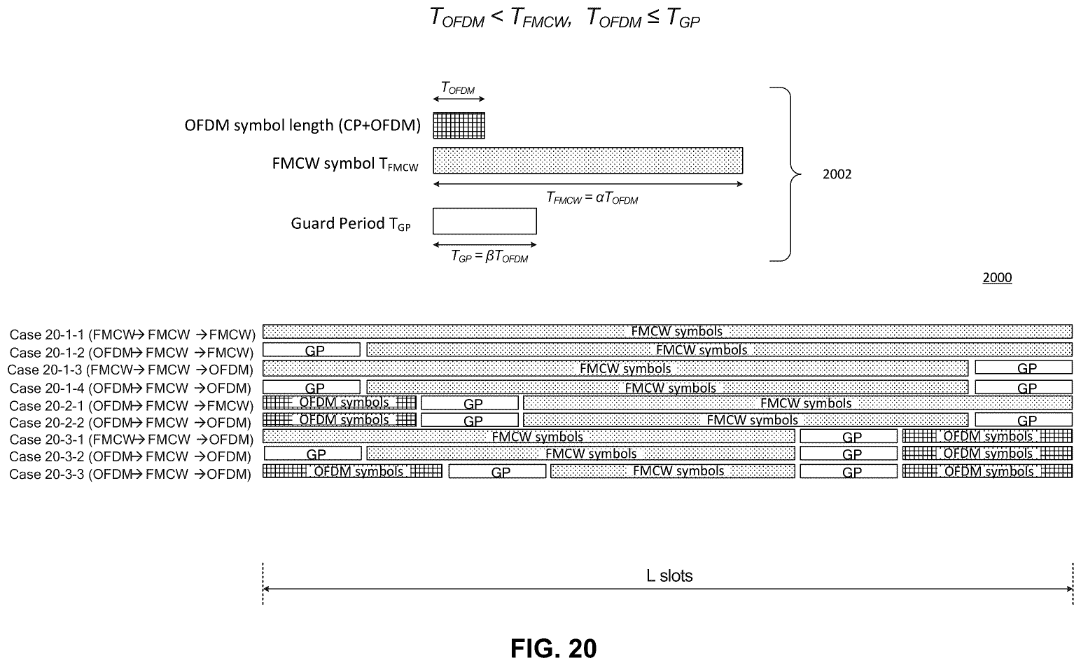

FIG. 20 illustrates a time-division multiplexing example 2000 in which the sensing waveform symbol duration (e.g., FMCW symbol length T_{FMCW}) is greater than or equal to the communication symbol duration (e.g., OFDM symbol length T_{OFDM}), the guard period duration (e.g., T_{GP}) is greater than or equal to the communication symbol duration, and the basic scheduling unit is a symbol, with transmission of joint communication and sensing signals spanning multiple slots. A communication device supports transmitting or receiving one or more consecutive communication symbols and/or one or more consecutive sensing symbols over multiple slots (e.g., L slots). Here, the sensing symbols and communication symbols are positioned such that symbol boundaries are aligned, but the boundaries of each slot may not be maintained. Instead, the starting boundary and ending boundary that bracket a group of multiple slots may be maintained.

Possible slot configurations according these embodiments may be characterized as follows. When Nₛₗₒₜ is the number of OFDM symbols in a slot (e.g., 14 symbols) and L consecutive slots are configured for sensing, the joint communication and sensing system supports scenarios in which T_{FMCW}=aT_{OFDM}, where a is an integer divisor of LNₛₗₒₜ. L may be a positive integer greater than 1. As shown in illustration 2002 (time scale different from example 2000), the FMCW symbol length T_{FMCW} is equal to α times the OFDM symbol length T_{OFDM}. The guard period duration T_{GP} is equal to β times the OFDM symbol length T_{OFDM}. Here, α and β are positive integers equal to or greater than 1. The communication device may transmit or receive M₀ consecutive communication symbols and M_{F} consecutive sensing symbols over L slots. M₀ and M_{F} are positive integers equal to or greater than 0. A sensing server may configure the communication device, e.g., by sending one or more configuration parameters, to specify (α, β, M_{F}, M₀) and one of the slot configuration types described below.

Thus, when M₀ OFDM symbols and M_{F} FMCW symbols are transmitted, one of the following equations is satisfied:

$${aM}_{F} = {LN}_{slot} , or \qquad ( case 20 - 1 - 1 )$$

$${aM}_{F} + b = {LN}_{slot} , or {aM}_{F} + 2 b = {LN}_{slot} \qquad ( case 20 - 1 - 2 and 20 - 1 - 3 )$$

$${M}_{0} + {aM}_{F} + b = {LN}_{slot} \qquad ( case 20 - 2 - 1 and case 20 - 3 - 1 )$$

$${M}_{0} + {aM}_{F} + 2 b = {LN}_{slot} \qquad ( case 20 - 2 - 2 , case 20 - 3 - 2 , and case 20 - 3 - 3 )$$

Given the constraints described above, the resulting slot may belong to one of a number of different slot configuration types, including:
a first slot configuration type (20-1-1), corresponding to a transmission of one or more consecutive sensing symbols occupying an entire duration of the slot,
a second slot configuration type (20-1-2), corresponding to a guard period, followed by a transmission of one or more consecutive sensing symbols,
a third slot configuration type (20-1-3), corresponding to a transmission of one or more consecutive sensing symbols, followed by a guard period,
a fourth slot configuration type (20-1-4), corresponding to a first guard period, followed by a transmission of one or more consecutive sensing symbols, followed by a second guard period,
a fifth slot configuration type (20-2-1), corresponding to a transmission of one or more consecutive communication symbols, followed by a guard period, followed by a transmission of one or more consecutive sensing symbols,
a sixth slot configuration type (20-2-2), corresponding to a transmission of one or more consecutive communication symbols, followed by a first guard period, followed by a transmission of one or more consecutive sensing symbols, followed by a second guard period,
a seventh slot configuration type (20-3-1), corresponding to a transmission of one or more consecutive sensing symbols, followed by a guard period, followed by a transmission of one or more consecutive communication symbols,
an eighth slot configuration type (20-3-2), corresponding to a first guard period, followed by a transmission of one or more consecutive sensing symbols, followed by a second guard period, followed by a transmission of one or more consecutive communication symbols, and
a ninth slot configuration type (20-3-3), corresponding to a transmission of one or more consecutive communication symbols, followed by a first guard period, followed by a transmission of one or more consecutive sensing symbols, followed by a second guard period, followed by a transmission of one or more consecutive communication symbols.

The generalized description of slot configurations described in the context of FIG. 20 can also be used to describe the slot configurations described in the context of FIG. 19, by narrowing the generalized description to a special case in which L=1.

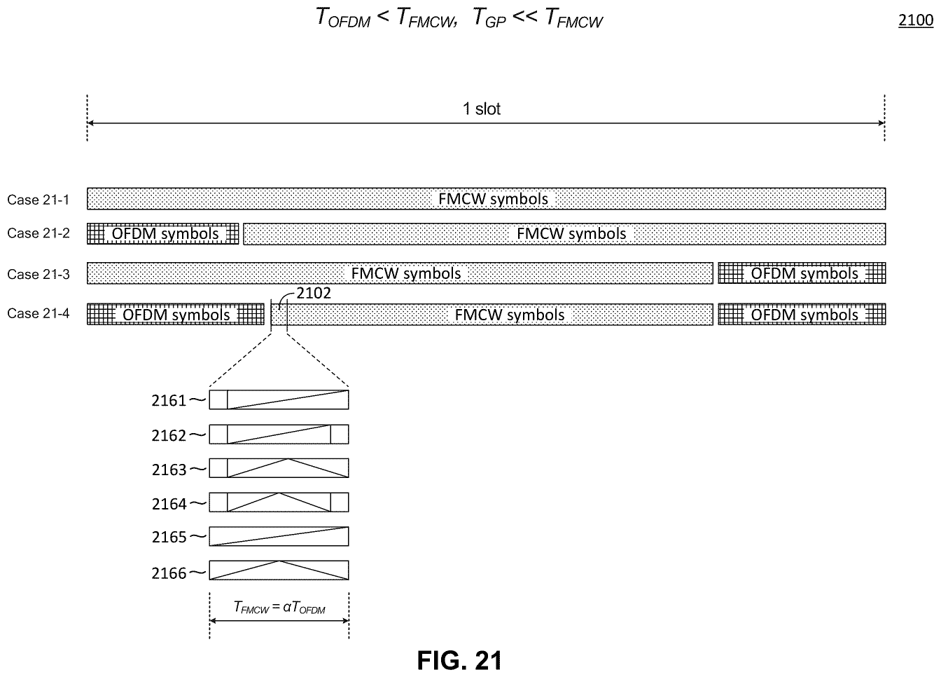

FIG. 21 illustrates a time-division multiplexing example 2100 in which the sensing waveform symbol duration (e.g., FMCW symbol length T_{FMCW}) is greater than or equal to the communication symbol duration (e.g., OFDM symbol length T_{OFDM}), the guard period duration (e.g., T_{GP}) is less than the communication symbol duration, and the basic scheduling unit is a symbol. In some embodiments, a communication device supports transmitting or receiving one or more consecutive communication symbols and/or one or more consecutive sensing symbols during a slot. Here, the sensing symbols and communication symbols are positioned such that symbol boundaries are aligned and each slot boundary is maintained. One or more guard periods are defined to separate the transmissions of the one or more consecutive communication symbols and the one or more consecutive sensing symbols. Each of the one or more guard periods has a duration T_{GP} less than a communication symbol. Thus, the guard period duration T_{GP} is not capable of being expressed as a number (e.g., several) times the OFDM symbol length T_{OFDM}. Indeed, in some instances, the guard period duration T_{GP} is markedly less than the OFDM symbol length T_{OFDM}. A guard period (GP) may be defined as part of each FMCW symbol, such as in a manner described previously in the context of FIG. 18A. Alternatively, no GP may be defined as part of each FMCW symbol, such as in a manner described previously in the context of FIG. 18B.

Possible slot configurations according these embodiments may be characterized as follows. When Nₛₗₒₜ is the number of OFDM symbols in a slot (e.g., 14 symbols), the joint communication and sensing system supports scenarios in which T_{FMCW}=aT_{OFDM}, where a is an integer divisor of Nₛₗₒₜ. As shown in illustration 2102 (time scale different from example 2100), the FMCW symbol length T_{FMCW} is equal to a times the OFDM symbol length T_{OFDM}. Here, a is a positive integers equal to or greater than 1. The communication device may transmit or receive M₀ consecutive communication symbols and M_{F} consecutive sensing symbols over a slot. M₀ and M_{F} are positive integers equal to or greater than 0. A sensing server may configure the communication device, e.g., by sending one or more configuration parameters, to specify (α, M_{F}, M₀) and one of the slot configuration types described below.

Thus, when M₀ OFDM symbols and M_{F} FMCW symbols are transmitted, one of the following equations is satisfied:

$${aM}_{F} = {N}_{slot} , \qquad ( case 21 - 1 )$$

$${M}_{0} + {aM}_{F} = {N}_{slot} \qquad ( cases 21 - 2 , 21 - 3 , and 21 - 4 )$$

For example, when Nₛₗₒₜ=14 (NR), one or more of the following cases may be supported:

(α, M_{F}, M₀)=(2, 1, 12), (2, 2, 10), (2, 3, 8), . . . , (2, 6, 2), or (2, 7, 0).

Given the constraints described above, the resulting slot may belong to one of a number of different slot configuration types, including:
a first slot configuration type (21-1), corresponding to a transmission of one or more consecutive sensing symbols occupying an entire duration of the slot,
a second slot configuration type (19-2), corresponding to a transmission of one or more consecutive communication symbols, followed by a transmission of one or more consecutive sensing symbols
a third slot configuration type (19-3), corresponding to a transmission of one or more consecutive sensing symbols, followed by a transmission of one or more consecutive communication symbols
a fourth slot configuration type (19-4), corresponding to a transmission of one or more consecutive communication symbols, followed by a transmission of one or more consecutive sensing symbols, followed by a transmission of one or more consecutive communication symbols

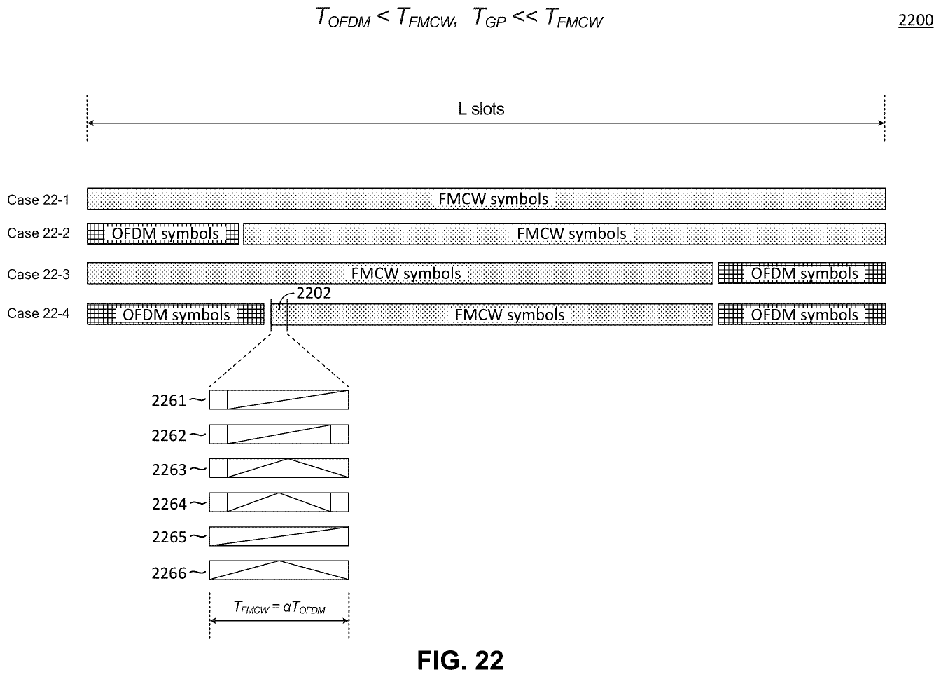

FIG. 22 illustrates a time-division multiplexing example 2200 in which the sensing waveform symbol duration (e.g., FMCW symbol length T_{FMCW}) is greater than or equal to the communication symbol duration (e.g., OFDM symbol length T_{OFDM}), the guard period duration (e.g., T_{GP}) is less than the communication symbol duration, and the basic scheduling unit is a symbol, with transmission of joint communication and sensing signals spanning multiple slots. A communication device supports transmitting or receiving one or more consecutive communication symbols and/or one or more consecutive sensing symbols over multiple slots (e.g., L slots). Here, the sensing symbols and communication symbols are positioned such that symbol boundaries are aligned, but the boundaries of each slot may not be maintained. Instead, the starting boundary and ending boundary that bracket a group of multiple slots may be maintained.

The guard period duration T_{GP} is not capable of being expressed as a number (e.g., several) times the OFDM symbol length T_{OFDM}. Indeed, in some instances, the guard period duration T_{GP} is markedly less than the OFDM symbol length T_{OFDM}. A guard period (GP) may be defined as part of each FMCW symbol, such as in a manner described previously in the context of FIG. 18A. Alternatively, no GP may be defined as part of each FMCW symbol, such as in a manner described previously in the context of FIG. 18B.

Possible slot configurations according these embodiments may be characterized as follows. When Nₛₗₒₜ is the number of OFDM symbols in a slot (e.g., 14 symbols) and L consecutive slots are configured for sensing, the joint communication and sensing system supports scenarios in which T_{FMCW}=aT_{OFDM}, where a is an integer divisor of LNₛₗₒₜ. L may be a positive integer greater than 1. As shown in illustration 2102 (time scale different from example 2100), the FMCW symbol length T_{FMCW} is equal to a times the OFDM symbol length T_{OFDM}. Here, α is a positive integers equal to or greater than 1. The communication device may transmit or receive M₀ consecutive communication symbols and M_{F} consecutive sensing symbols over L slots. M₀ and M_{F} are positive integers equal to or greater than 0. A sensing server may configure the communication device, e.g., by sending one or more configuration parameters, to specify (α, M_{F}, M₀) and one of the slot configuration types described below.

Thus, when M₀ OFDM symbols and M_{F} FMCW symbols are transmitted, one of the following equations is satisfied:

$${aM}_{F} = {LN}_{slot} , \qquad ( case 21 - 1 )$$

$${M}_{0} + {aM}_{F} = {LN}_{slot} \qquad ( cases 21 - 2 , 21 - 3 , and 21 - 4 )$$

Given the constraints described above, the resulting slot may belong to one of a number of different slot configuration types, including:
a first slot configuration type (21-1), corresponding to a transmission of one or more consecutive sensing symbols occupying an entire duration of the slot,
a second slot configuration type (19-2), corresponding to a transmission of one or more consecutive communication symbols, followed by a transmission of one or more consecutive sensing symbols
a third slot configuration type (19-3), corresponding to a transmission of one or more consecutive sensing symbols, followed by a transmission of one or more consecutive communication symbols
a fourth slot configuration type (19-4), corresponding to a transmission of one or more consecutive communication symbols, followed by a transmission of one or more consecutive sensing symbols, followed by a transmission of one or more consecutive communication symbols

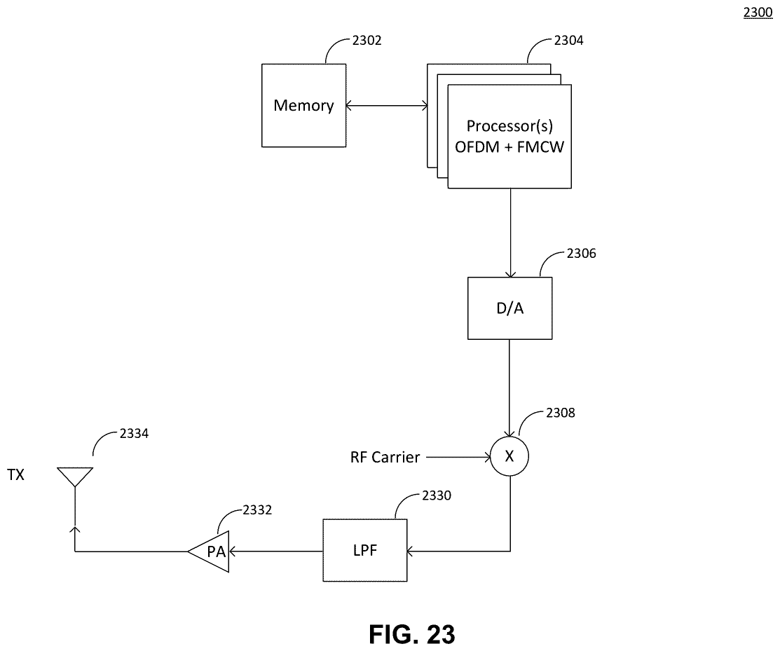

FIGS. 23-26 illustrate various configurations for transmitting or receiving time-division multiplexed (TDM) joint communication and sensing (JCS) signals, according to different embodiments of the disclosure. From a transmitter perspective, an FMCW could be implemented digitally or as an analog signal. In a scenario where the same or similar bandwidth is used for RF sensing and communications, some embodiments of the disclosure may utilize one set of hardware for generating both FMCW signals and OFDM signals. In a scenario where the RF sensing bandwidth is much larger than communications bandwidth, the UE may utilize a separate set of hardware (e.g., VCO-based analog device) for generating the FMCW signal. In such cases, where two sets of HW are used, timing alignment is implemented between the analog FMCW signal generation and the digital OFDM signal generation, according to some embodiments of the disclosure. For example, a UE may be implemented to be capable of calibrating the two sets of hardware to achieve satisfactory timing alignment between the analog FMCW signal and the digital OFDM signal.

From a receiver perspective, a UE may implement an FMCW receiver utilizing a VCO-based implementation, in order to reduce the sampling rate/bandwidth requirements placed on the A/D converter and thereby reducing cost (as discussed in previous sections). Such a VCO-based, analog FMCW receiver implementation may be used, for example, for FR2/FR3/THz downlink bistatic RF sensing with a large RF sensing signal BW, to achieve significant cost savings at the UE side. In such an implementation, the UE may have two sperate hardware chains for receiving and processing of OFDM and FMCW signals.

FIG. 23 presents a portion 2300 of a communication device implementing transmission of TDM multiplexed JCS signals using a single set of hardware for generating both FMCW and OFDM signals, according to some embodiments of the disclosure. Portion 2300 represents an example of a device for transmitting signals for communication and sensing comprising a memory, one or more processors coupled to the memory, a digital-to-analog (D/A) converter coupled to the one or more processors, and one or more antennas coupled to the D/A converter. The one or more processors are configured to generate a digital signal comprising (1) one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure, and (2) one or more communication signals within the air interface frame structure, wherein the one or more communication signals occupy a second subset of symbols in the plurality of symbols of the air interface frame structure. The one or more sensing signals comprise one or more sensing waveforms, each of the one or more sensing waveforms being associated with a sensing waveform symbol duration, the sensing waveform symbol duration being aligned with one or more symbol boundaries of the air interface frame structure. The one or more communication signals comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration. The D/A converter is configured generate an analog signal based on the digital signal. The one or more antennas are configured to transmit a radio frequency (RF) signal based on the analog signal.

The components shown in FIG. 23 are merely illustrative, and alternative implementations may include different components arranged in various ways to achieve the same or similar functionality. As shown, portion 2300 includes a memory 2302, one or more processors 2304, a D/A converter 2306, a mixer 2308, a low-pass filter 2330, a power amplifier 2332, and one or more antennas 2336. The one or more processors 2304 generate one or more sensing signals (e.g., FMCW signals) within the air interface frame structure, wherein the one or more sensing signals occupy a first subset symbols in the plurality of symbols of the air interface frame structure. The one or more processors 2304 also obtain data symbols from higher-level protocols and modulate the data symbols as one or more communication signals (e.g., OFDM symbols) within the air interface frame structure, wherein the one or more communication signals occupy a second subset of symbols in the plurality of symbols of the air interface frame structure. The one or more processors 2304 thus generates, in digital form, a TDM multiplexed JCS signal. The D/A converter 2306 receives the digital TDM multiplexed JCS signal and converts it to an analog signal. The mixer 2308 mixes the analog signal from an intermediate frequency (IF) to a radio frequency (RF). The low-pass filter 30 filters the analog RF signal. The power amplifier 2332 amplifies the filtered, analog RF signal. The one or more antennas 2334 then transmit the power amplified signal.

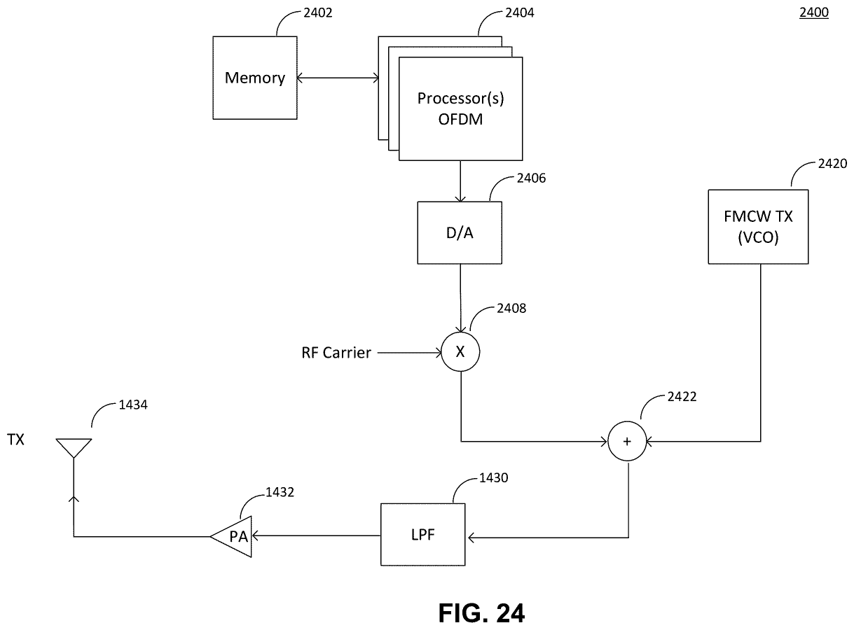

FIG. 24 presents a portion 2400 of a communication device implementing transmission of TDM multiplexed JCS signals using one set of hardware for generating FMCW signals and another set of hardware for generating OFDM signals, according to some embodiments of the disclosure. Portion 2400 represents an example of a device for transmitting signals for communication and sensing comprising a memory, one or more processors coupled to the memory, a digital-to-analog (D/A) converter coupled to the one or more processors, a frequency modulated continuous wave (FMCW) signal generator, a combiner coupled to the D/A converter and the FMCW signal generator, and one or more antennas coupled to the combiner. The FMCW signal generator is configured to generate, as a first analog signal, one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure. The one or more processors are configured to generate, as a digital signal, one or more communication signals within the air interface frame structure, wherein the one or more communication signals occupy a second subset of symbols in the plurality of symbols of the air interface frame structure. The D/A converter is configured to generate a second analog signal based on the digital signal. The combiner is configured to generate a combined analog signal based on first analog signal and the second analog signal. The one or more antennas are configured to transmit a radio frequency (RF) signal based on the combined analog signal.

The components shown in FIG. 24 are merely illustrative, and alternative implementations may include different components arranged in various ways to achieve the same or similar functionality. As shown, portion 2400 includes a memory 2402, one or more processors 2404, a D/A converter 2406, a mixer 2408, a FMCW signal generator 2420, a combiner 2422, a low-pass filter 2430, a power amplifier 2432, and one or more antennas 2434. An FMCW signal generator 2420 generates one or more sensing signals (e.g., FMCW signals) within the air interface frame structure, wherein the one or more sensing signals occupy a first subset symbols in the plurality of symbols of the air interface frame structure. The FMCW signal generator 2420 may be implemented using, e.g., a VCO, to generate the analog FMCW transmit signal with time-varying frequency. The one or more processors 2404 obtain data symbols from −level protocols and modulate the data symbols as one or more higher communication signals (e.g., OFDM symbols) within the air interface frame structure, wherein the one or more communication signals occupy a second subset of symbols in the plurality of symbols of the air interface frame structure, as a digital OFDM signal. The one or more processors 2404 may perform operations described herein by carrying out executable instructions stored in the memory 2402. The D/A converter 2406 converts the digital OFDM signal into an analog OFDM signal. The mixer 2408 converts the analog OFDM signal from an intermediate frequency (IF) to a radio frequency (RF). The combiner 2422 combines the analog OFDM signal with the analog FMCW transmit signal to produce a TDM multiplexed JCS signal. According to aspects of the disclosure, the one or more processors 2404 and the FMCW signal generator 2420 are synchronized to facilitate time-aligning the analog OFDM signal and the analog FMCW transmit signal prior to combining the two analog signals. The low-pass filter 2430 filters the RE-level FDM multiplexed JCS signal. The power amplifier 2332 amplifies the filtered signal. The one or more antennas 2334 then transmit the power amplified signal.

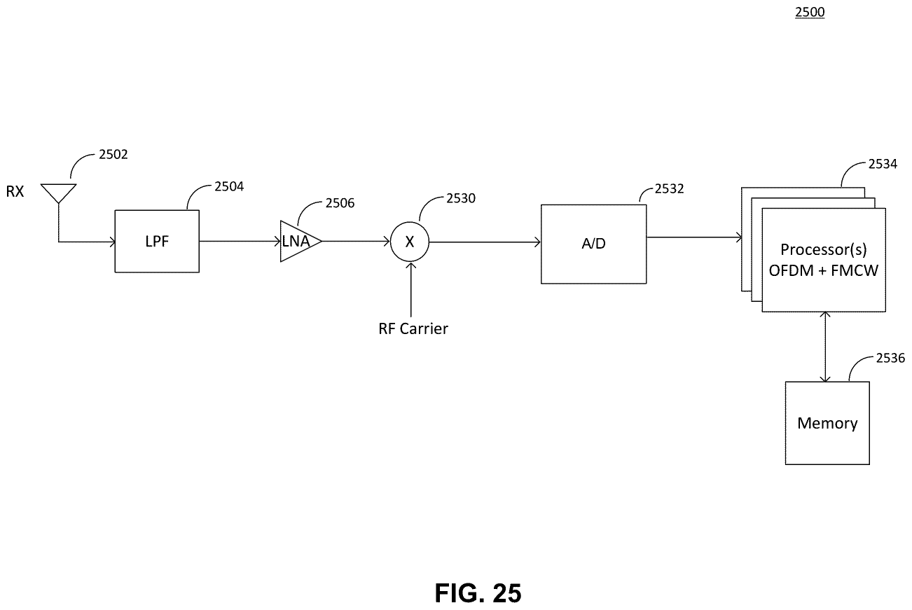

FIG. 25 presents a portion 2500 of a communication device implementing reception of TDM multiplexed JCS signals using a single set of hardware for processing of both received FMCW and received OFDM signals, according to some embodiments of the disclosure. Portion 2500 represents an example of a device for receiving signals for communication and sensing comprising one or more antennas, an analog-to-digital (A/D) converter coupled to the one or more antennas, one or more processors coupled to the A/D converter, and a memory coupled to the one or more processors. The one or more antennas are configured to receive a radio frequency (RF) signal, the RF signal comprising (1) one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure, and (2) one or more communication signals within the air interface frame structure, wherein the one or more communication signals occupy a second subset of symbols in the plurality of symbols of the air interface frame structure. The one or more sensing signals comprise one or more sensing waveforms, each of the one or more sensing waveforms being associated with a sensing waveform symbol duration, the sensing waveform symbol duration being aligned with one or more symbol boundaries of the air interface frame structure. The one or more communication signals comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration. The A/D converter is configured to generate a digital signal based on the RF signal. The one or more processors are configured receive the digital signal and (1) generate one or more of a range estimate, a Doppler estimate, and/or an Angle of Arrival (AoA) estimate based on the FMCW signal as represented in the digital signal and (2) generate demodulated data symbols based on the plurality of OFDM signals as represented in the digital signal.

The components shown in FIG. 25 are merely illustrative, and alternative implementations may include different components arranged in various ways to achieve the same or similar functionality. As shown, portion 2500 includes one or more antennas 2502, a low pass filter (LPF) 2504, a low noise amplifier (LNA) 2506, a mixer 2530, an A/D converter 2532, one or more processors 2534, and a memory 2536. The one or more antennas 2502 receive a TDM multiplexed JCS signal comprising (1) one or more sensing signals within the air interface frame structure, wherein the one or more sensing signals occupy a first subset symbols in the plurality of symbols of the air interface frame structure, and (2) one or more communication signals within the air interface frame structure, wherein the one or more communication signals occupy a second subset of symbols in the plurality of symbols of the air interface frame structure. The low-pass filter 2504 filters the received TDM multiplexed JCS signal. The LNA 2506 amplifies the filtered signal. The mixer 2530 down-converts the amplified, filtered signal from an RF frequency to an IF frequency. The A/D converter 2532 converts the IF signal from analog to digital form. The one or more processors 2534 receives and processes the digital IF JCS signal. Here, the one or more processors 2534 performs both (1) demodulation of the OFDM data symbols from the OFDM portion of the digital IF JCS signal, to generate received data symbols and (2) processing of the FMCW portion of the digital IF JCS signal to generate range, Doppler, and/or AoA estimates. Processing of the FMCW portion of the signal may be similar to that shown in FIG. 5, but with operations including mixing (e.g., mixer 508) and filtering (e.g., LPF 510) performed in digital form, without use of a VCO. The one or more processors 2534 may perform such operations by carrying out executable instructions stored in the memory 2536.

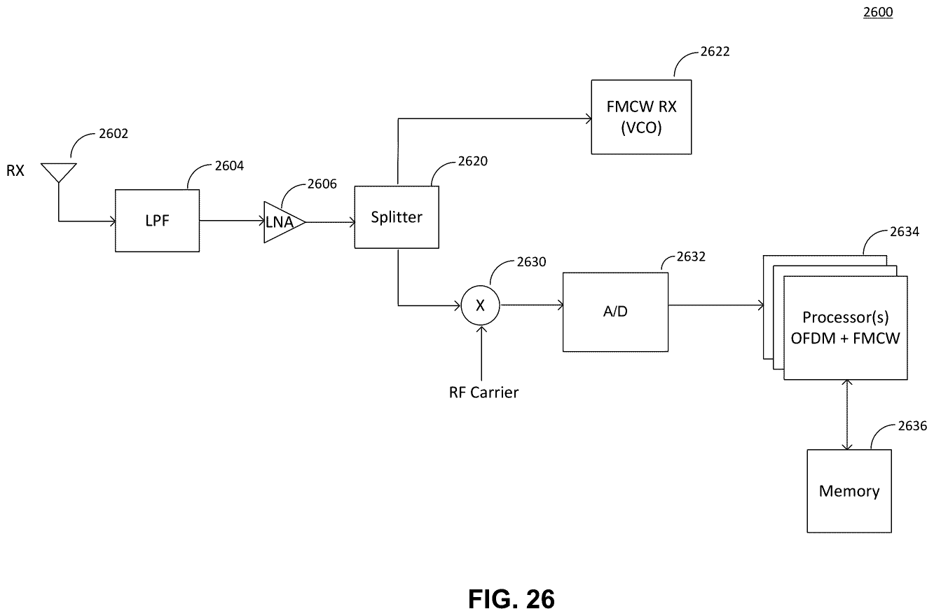

FIG. 26 presents a portion 2600 of a communication device implementing reception of TDM multiplexed JCS signals using one set of hardware for processing of received FMCW signals and another set of hardware for processing of received OFDM signals, according to some embodiments of the disclosure. Portion 2600 represents an example of a device for receiving signals for communication and sensing comprising one or more antennas a signal splitter, a frequency modulated continuous wave (FMCW) receiver coupled to the signal splitter, an analog-to-digital (A/D) converter coupled to the signal splitter, one or more processors coupled to the A/D converter, a memory coupled to the one or more processors. The one or more antennas are configured to receive a radio frequency (RF) signal, the RF signal comprising (1) one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure, and (2) one or more communication signals within the air interface frame structure, wherein the one or more communication signals occupy a second subset of symbols in the plurality of symbols of the air interface frame structure. The one or more sensing signals comprise one or more sensing waveforms, each of the one or more sensing waveforms being associated with a sensing waveform symbol duration, the sensing waveform symbol duration being aligned with one or more symbol boundaries of the air interface frame structure. The one or more communication signals comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration. The splitter is configured to generate a first split signal and a second split signal based on the RF signal. The FMCW receiver is configured to generate one or more of a range estimate, a Doppler estimate, and/or an Angle of Arrival (AoA) estimate based on the FMCW signal as represented in the first split signal. The A/D converter is configured to generate a digital signal based on the second split signal. The one or more processors are configured to generate demodulated data symbols based on the digital signal.

The components shown in FIG. 26 are merely illustrative, and alternative implementations may include different components arranged in various ways to achieve the same or similar functionality. As shown, portion 2600 includes one or more antennas 2602, a low pass filter (LPF) 2604, a low noise amplifier (LNA) 2606, a splitter 2620, an FMCW receiver 2622, a mixer 2630, an A/D converter 2632, one or more processors 2634, and a memory 2636. The one or more antennas 2602 receive a TDM multiplexed JCS signal comprising (1) one or more sensing signals (e.g., FMCW signals) within the air interface frame structure, wherein the one or more sensing signals occupy a first subset symbols in the plurality of symbols of the air interface frame structure, and (2) one or more communication signals (e.g., OFDM signals) within the air interface frame structure, wherein the one or more communication signals occupy a second subset of symbols in the plurality of symbols of the air interface frame structure, as described previously. The low pass filter 2604 filters the received TDM multiplexed JCS signal. The LNA 2606 amplifies the filtered signal. The splitter 2620 splits the filtered and amplified JCS signal into a first split signal and a second split signal. The FMCW receiver 2622 receives the first split signal and processes the FMCW signal contain therein and generate one or more of a range estimate, a Doppler estimate, or an AoA estimate. The FMCW receiver 2622 may be implemented using a VCO to generate a version of the analog FMCW transmit signal with time-varying frequency, as well as a D/A converter with a relatively low sampling rate. The mixer 2630 down converts the second split signal from an RF frequency to an IF frequency. The A/D converter 2632 converts the IF signal from analog to digital form. The one or more processors 2634 demodulates the OFDM portion of the digital IF JCS signal, to generate received data symbols. The one or more processors 2634 may perform such operations by carrying out executable instructions stored in the memory 2636.

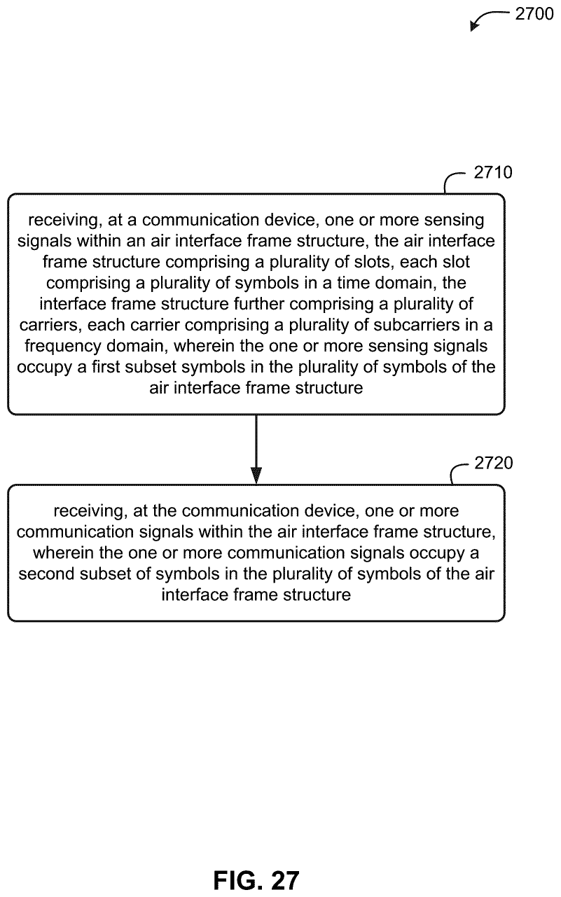

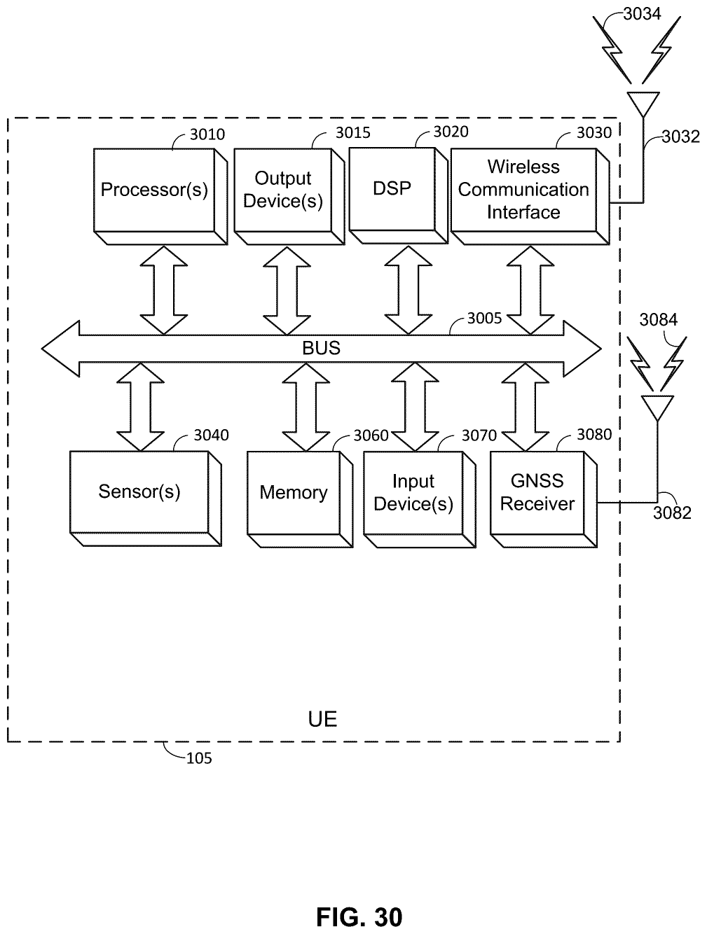

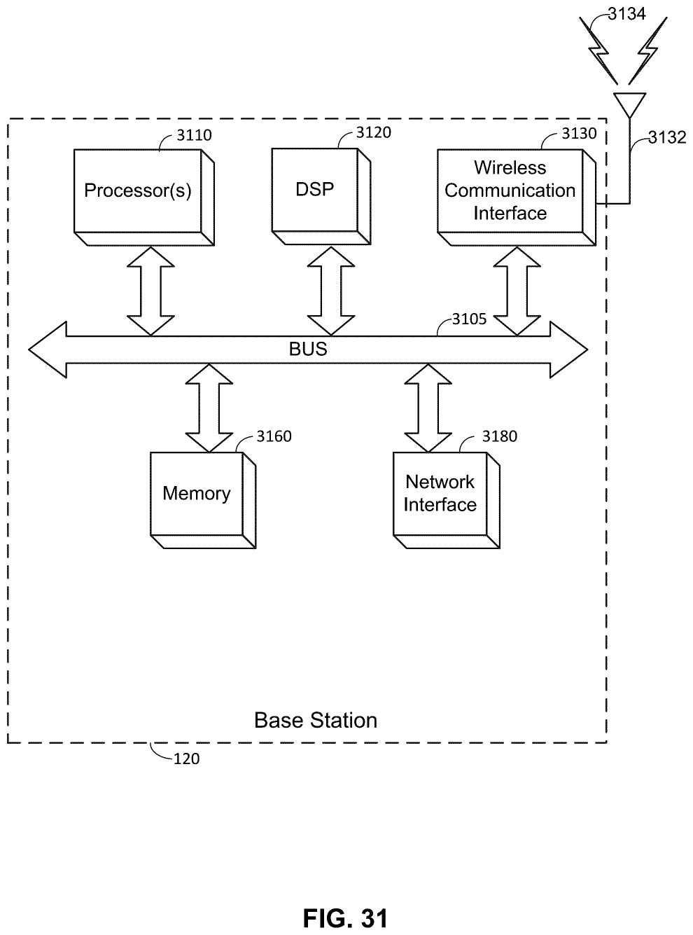

FIG. 27 is a flow diagram of a method 2700 of receiving signals for communication and sensing, according to an embodiment. Means for performing the functionality illustrated in one or more of the blocks shown in FIG. 27 may be performed by hardware and/or software components of, for example, a UE and/or a base station. Example components of a UE and a base station are illustrated FIGS. 30 and 31, which are described in more detail in later sections.

At block 2710, the functionality comprises receiving, at a communication device, one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure. Means for performing the functionality at block 2710 may comprise one or more antennas, a low-pass filter, a low noise amplifier, a mixer, a splitter, an FMCW receiver, an A/D converter, one or more processors, a memory, and/or other components of a UE or a base station, as illustrated in FIGS. 25 and/or 26.

At block 2720, the functionality comprises receiving, at the communication device, one or more communication signals within the air interface frame structure, wherein the one or more communication signals occupy a second subset of symbols in the plurality of symbols of the air interface frame structure. Means for performing the functionality at block 2720 may comprise one or more antennas, a low-pass filter, a low noise amplifier, a mixer, a splitter, an A/D converter, one or more processors, a memory, and/or other components of a UE or a base station, as illustrated in FIGS. 25 and/or 26.

The one or more sensing signals may comprise one or more sensing waveforms, each of the one or more sensing waveforms being associated with a sensing waveform symbol duration, the sensing waveform symbol duration being aligned with one or more symbol boundaries of the air interface frame structure. The one or more communication signals may comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration.

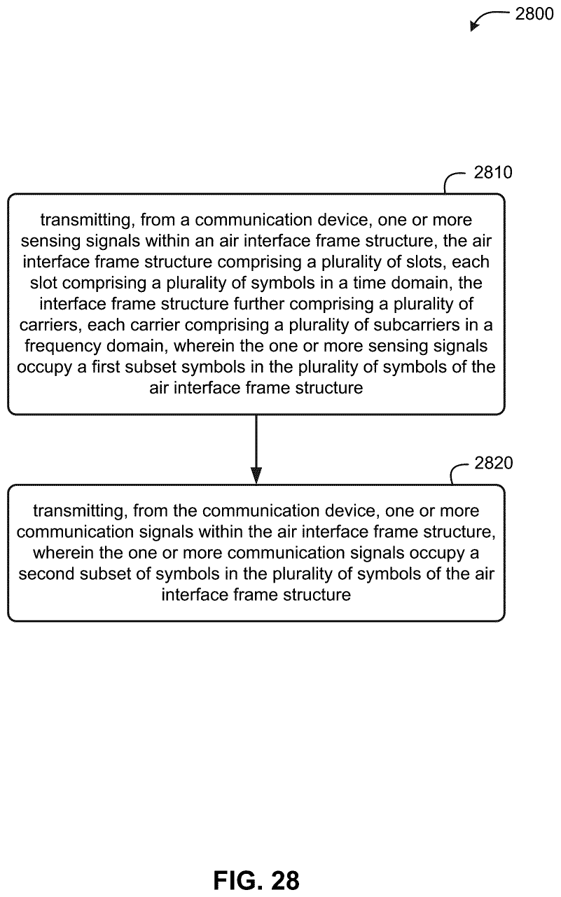

FIG. 28 is a flow diagram of a method 2800 of transmitting signals for communication and sensing, according to an embodiment. Means for performing the functionality illustrated in one or more of the blocks shown in FIG. 28 may be performed by hardware and/or software components of, for example, a UE and/or a base station. Example components of a UE and a base station are illustrated FIGS. 30 and 31, which are described in more detail in later sections.

At block 2810, the functionality comprises transmitting, from a communication device, one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure. Means for performing the functionality at block 2810 may comprise a memory, one or more processors, a D/A converter, a mixer, an FMCW signal generator, a combiner, a low-pass filter, a power amplifier, one or more antennas, and/or other components of a UE or a base station, as illustrated in FIGS. 23 and/or 24.

At block 2820, the functionality comprises transmitting, from the communication device, one or more communication signals within the air interface frame structure, wherein the one or more communication signals occupy a second subset of symbols in the plurality of symbols of the air interface frame structure. Means for performing the functionality at block 2820 may comprise a memory, one or more processors, a D/A converter, a mixer, a combiner, a low-pass filter, a power amplifier, one or more antennas, and/or other components of a UE or a base station, as illustrated in FIGS. 23 and/or 24.

The one or more sensing signals may comprise one or more sensing waveforms, each of the one or more sensing waveforms being associated with a sensing waveform symbol duration, the sensing waveform symbol duration being aligned with one or more symbol boundaries of the air interface frame structure. The one or more communication signals may comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration.

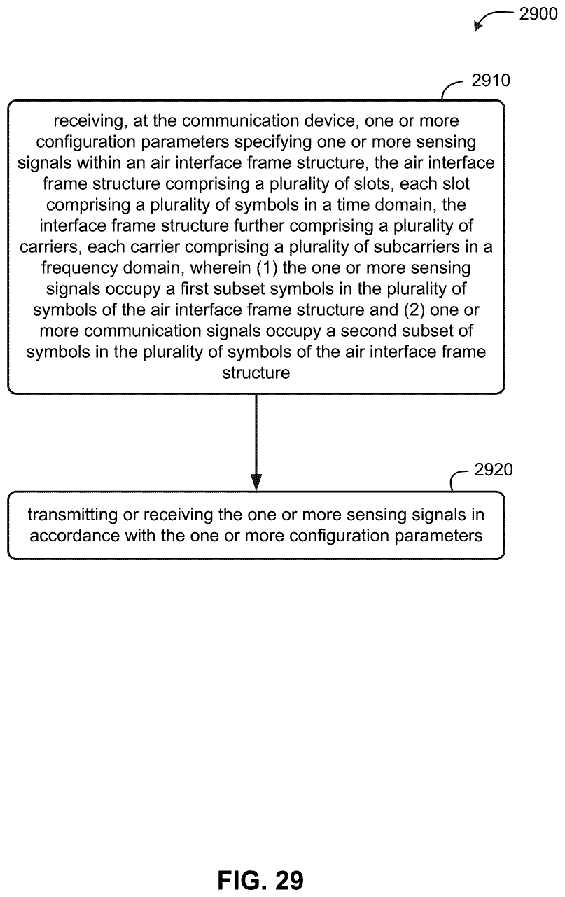

FIG. 29 is a flow diagram of a method 2900 of operating a communication device for communication and sensing, according to an embodiment. Means for performing the functionality illustrated in one or more of the blocks shown in FIG. 29 may be performed by hardware and/or software components of, for example, a UE and/or a base station. Example components of a UE and a base station are illustrated FIGS. 30 and 31, which are described in more detail in later sections.

At block 2910, the functionality comprises receiving, at the communication device, one or more configuration parameters specifying one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein (1) the one or more sensing signals occupy a first subset symbols in the plurality of symbols of the air interface frame structure and (2) one or more communication signals occupy a second subset of symbols in the plurality of symbols of the air interface frame structure. Means for performing the functionality at block 2910 may comprise one or more antennas, a low-pass filter, a low noise amplifier, a mixer, a splitter, an FMCW receiver, an A/D converter, one or more processors, a memory, and/or other components of a UE or a base station, as illustrated in FIGS. 25 and/or 26.

At block 2920, the functionality comprises transmitting or receiving the one or more sensing signals in accordance with the one or more configuration parameters. Means for performing a transmission portion of the functionality at block 2920 may comprise a memory, one or more processors, a D/A converter, a mixer, an FMCW signal generator, a combiner, a low-pass filter, a power amplifier, one or more antennas, and/or other components of a UE or a base station, as illustrated in FIGS. 23 and/or 24. Means for performing a reception portion of the functionality at block 2920 may comprise one or more antennas, a low-pass filter, a low noise amplifier, a mixer, a splitter, an FMCW receiver, an A/D converter, one or more processors, a memory, and/or other components of a UE or a base station, as illustrated in FIGS. 25 and/or 26.

The one or more sensing signals may comprise one or more sensing waveforms, each of the one or more sensing waveforms being associated with a sensing waveform symbol duration, the sensing waveform symbol duration being aligned with one or more symbol boundaries of the air interface frame structure. The one or more communication signals may comprise one or more communication symbols, each of the one or more communication symbols being associated with a communication symbol duration, the communication symbol duration being aligned with one or more symbol boundaries of the air interface frame structure. The sensing waveform symbol duration is greater than or equal to the communication symbol duration.

FIG. 30 is a block diagram of an embodiment of a UE 105, which can be utilized as described herein above (e.g., in association with FIGS. 5, 23, 24, 25, and/or 26). For example, the UE 105 can perform one or more of the functions of the method shown in FIGS. 27 and/or 28. It should be noted that FIG. 30 is meant only to provide a generalized illustration of various components, any or all of which may be utilized as appropriate. It can be noted that, in some instances, components illustrated by FIG. 30 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 30.

The UE 105 is shown comprising hardware elements that can be electrically coupled via a bus 3005 (or may otherwise be in communication, as appropriate). The hardware elements may include a processor(s) 3010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 3010 may comprise one or more processing units, which may be housed in a single integrated circuit (IC) or multiple ICs. As shown in FIG. 30, some embodiments may have a separate DSP 3020, depending on desired functionality. Location determination and/or other determinations based on wireless communication may be provided in the processor(s) 3010 and/or wireless communication interface 3030 (discussed below). The UE 105 also can include one or more input devices 3070, which can include without limitation one or more keyboards, touch screens, touch pads, microphones, buttons, dials, switches, and/or the like; and one or more output devices 3015, which can include without limitation one or more displays (e.g., touch screens), light emitting diodes (LEDs), speakers, and/or the like.

The UE 105 may also include a wireless communication interface 3030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 3030 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 3032 that send and/or receive wireless signals 3034. According to some embodiments, the wireless communication antenna(s) 3032 may comprise a plurality of discrete antennas, antenna arrays, or any combination thereof. The antenna(s) 3032 may be capable of transmitting and receiving wireless signals using beams (e.g., Tx beams and Rx beams). Beam formation may be performed using digital and/or analog beam formation techniques, with respective digital and/or analog circuitry. The wireless communication interface 3030 may include such circuitry.

Depending on desired functionality, the wireless communication interface 3030 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 3040. Sensor(s) 3040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 3080 capable of receiving signals 3084 from one or more GNSS satellites using an antenna 3082 (which could be the same as antenna 3032). Positioning based on GNSS signal measurement can be utilized to complement and/or incorporate the techniques described herein. The GNSS receiver 3080 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 3080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 3080 is illustrated in FIG. 30 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 3010, DSP 3020, and/or a processor within the wireless communication interface 3030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 3010 or DSP 3020.

The UE 105 may further include and/or be in communication with a memory 3060. The memory 3060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 3060 of the UE 105 also can comprise software elements (not shown in FIG. 30), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 3060 that are executable by the UE 105 (and/or processor(s) 3010 or DSP 3020 within UE 105). In some embodiments, then, such code and/or instructions can be used to configure and/or adapt a general-purpose computer (or other device) to perform one or more operations in accordance with the described methods.

FIG. 31 is a block diagram of an embodiment of a base station 120, which can be utilized as described herein above (e.g., in association with FIGS. 5, 23, 24, 25, and/or 26). For example, the UE 105 can perform one or more of the functions of the method shown in FIGS. 27 and/or 28. It should be noted that FIG. 31 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 3105 (or may otherwise be in communication, as appropriate). The hardware elements may include a processor(s) 3110 which can include without limitation one or more general-purpose processors, one or more special-purpose processors (such as DSP chips, graphics acceleration processors, ASICs, and/or the like), and/or other processing structure or means. As shown in FIG. 31, some embodiments may have a separate DSP 3120, depending on desired functionality. Location determination and/or other determinations based on wireless communication may be provided in the processor(s) 3110 and/or wireless communication interface 3130 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 3130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 3130 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 3132 that send and/or receive wireless signals 3134.

The base station 120 may also include a network interface 3180, which can include support of wireline communication technologies. The network interface 3180 may include a modem, network card, chipset, and/or the like. The network interface 3180 may include one or more input and/or output communication interfaces to permit data to be exchanged with a network, communication network servers, computer systems, and/or any other electronic devices described herein.

In many embodiments, the base station 120 may further comprise a memory 3160. The memory 3160 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 3160 of the base station 120 also may comprise software elements (not shown in FIG. 31), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 3160 that are executable by the base station 120 (and/or processor(s) 3110 or DSP 3120 within base station 120). In some embodiments, then, such code and/or instructions can be used to configure and/or adapt a general-purpose computer (or other device) to perform one or more operations in accordance with the described methods.

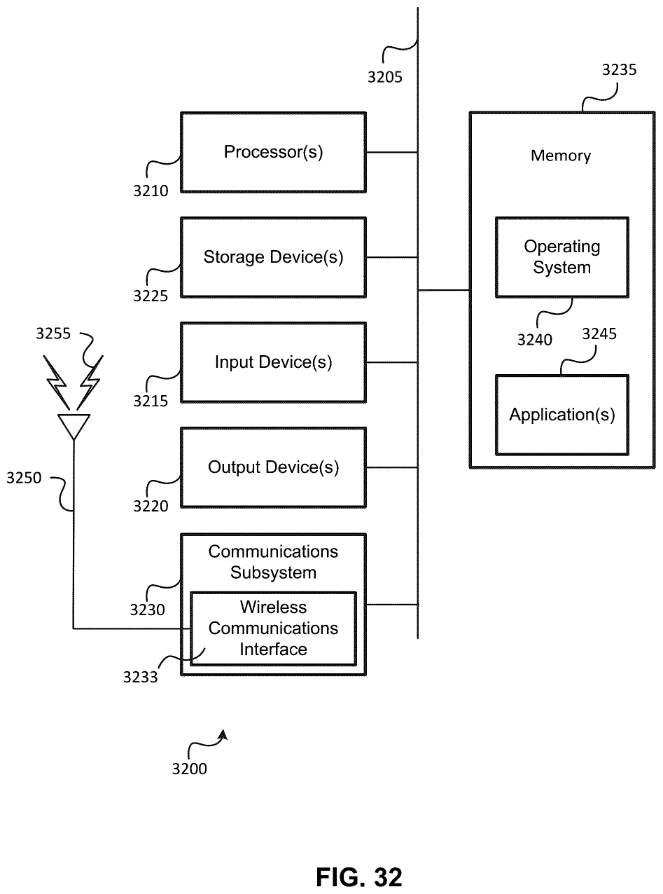

FIG. 32 is a block diagram of an embodiment of a computer system 3200, which may be used, in whole or in part, to provide the functions of one or more network components as described in the embodiments herein (e.g., location server 160 of FIG. 1). It should be noted that FIG. 32 is meant only to provide a generalized illustration of various components, any or all of which may be utilized as appropriate. FIG. 32, therefore, broadly illustrates how individual system elements may be implemented in a relatively separated or relatively more integrated manner. In addition, it can be noted that components illustrated by FIG. 32 can be localized to a single device and/or distributed among various networked devices, which may be disposed at different geographical locations.

The computer system 3200 is shown comprising hardware elements that can be electrically coupled via a bus 3205 (or may otherwise be in communication, as appropriate). The hardware elements may include processor(s) 3210, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 3200 also may comprise one or more input devices 3215, which may comprise without limitation a mouse, a keyboard, a camera, a microphone, and/or the like; and one or more output devices 3220, which may comprise without limitation a display device, a printer, and/or the like.

The computer system 3200 may further include (and/or be in communication with) one or more non-transitory storage devices 3225, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 3200 may also include a communications subsystem 3230, which may comprise wireless communication technologies managed and controlled by a wireless communication interface 3233, as well as wired technologies (such as Ethernet, coaxial communications, universal serial bus (USB), and the like). The wireless communication interface 3233 may comprise one or more wireless transceivers that may send and receive wireless signals 3255 (e.g., signals according to 5G NR or LTE) via wireless antenna(s) 3250. Thus the communications subsystem 3230 may comprise a modem, a network card (wireless or wired), an infrared communication device, a wireless communication device, and/or a chipset, and/or the like, which may enable the computer system 3200 to communicate on any or all of the communication networks described herein to any device on the respective network, including a User Equipment (UE), base stations and/or other TRPs, and/or any other electronic devices described herein. Hence, the communications subsystem 3230 may be used to receive and send data as described in the embodiments herein.

In many embodiments, the computer system 3200 will further comprise a working memory 3235, which may comprise a RAM or ROM device, as described above. Software elements, shown as being located within the working memory 3235, may comprise an operating system 3240, device drivers, executable libraries, and/or other code, such as one or more applications 3245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 3225 described above. In some cases, the storage medium might be incorporated within a computer system, such as computer system 3200. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 3200 and/or might take the form of source and/or installable code, which, upon compilation and/or installation on the computer system 3200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of receiving signals for communication and sensing comprising: receiving, at a communication device, one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure; and receiving, at the communication device, one or more communication signals within the air interface frame structure, wherein the one or more communication signals occupy a second subset of symbols in the plurality of symbols of the air interface frame structure, wherein the one or more sensing signals comprise one or more sensing waveforms, each of the one or more sensing waveforms being associated with a sensing waveform symbol duration, the sensing waveform symbol duration being aligned with one or more symbol boundaries of the air interface frame structure, wherein the one or more communication signals comprise one or more communication symbols, each of the one or more communication symbols being associated with a communication symbol duration, the communication symbol duration being aligned with one or more symbol boundaries of the air interface frame structure, and wherein the sensing waveform symbol duration is greater than or equal to the communication symbol duration.

Clause 2: The method of clause 1, wherein the one or more sensing signals comprise one or more frequency modulated continuous wave (FMCW) signals.

Clause 3: The method of any one of clauses 1-2 wherein the one or more communication signals comprise one or more orthogonal frequency-division multiplexing (OFDM) signals.

Clause 4: The method of any one of clauses 1-3 wherein the one or more sensing signals occupy one or more sensing signal bandwidths, wherein the one or more communication signals occupy one or more communication signal bandwidths, wherein the one or more sensing signal bandwidths at least partially overlap the one or more communication signal bandwidths, and wherein the one or more sensing signal bandwidths and the one or more communication signal bandwidths are separately configurable.

Clause 5: The method of any one of clauses 1-4 wherein the sensing waveform symbol duration is equal to the communication symbol duration.

Clause 6: The method of clause 5 wherein each of the one or more sensing signals spans one or more sensing slots comprising a first subset of the plurality of slots of the air interface frame structure, and wherein each of the one or more communication signals spans one or more communication slots comprising a second subset of the plurality of slots of the air interface frame structure.

Clause 7: The method of clause 6 wherein the one or more sensing slots and the one or more communication slots are defined based on a periodic schedule within the air interface frame structure.

Clause 8: The method of clause 7 wherein the periodic schedule is defined using at least (1) a sensing offset parameter, (2) a sensing period parameter, and (3) a sensing duration parameter.

Clause 9: The method of clause 7 wherein the periodic schedule is defined using at least (1) a sensing offset parameter, (2) a sensing period parameter, (3) a sensing duration parameter, (4) a number of repetitions parameter, (5) a gap between repetitions parameter, and (6) a sensing repetition offset parameter.

Clause 10: The method of clauses 6 wherein the one or more sensing slots and the one or more communication slots are defined based on an aperiodic schedule within the air interface frame structure.

Clause 11: The method of any one of clauses 6-10 wherein the one or more sensing slots are configurable between (1) an activated state in which the one or more sensing slots are used for sensing signals and (2) a deactivated state in which the one or more sensing slots are used for communication signals.

Clause 12: The method of any one of clauses 5-11 wherein the communication device supports receiving one or more consecutive communication symbols and receiving one or more consecutive sensing symbols during a slot of the plurality of slots.

Clause 13: The method of clause 12 further comprising receiving, at the communication device, a first slot configuration parameter specifying a number of consecutive sensing symbols and a second slot configuration parameter specifying a starting sensing symbol.

Clause 14: The method of any one of clauses 12-13 wherein the communication device supports (1) a first type of transition occurring during the slot, from a transmission of one or more consecutive communication symbols to a transmission of one or more consecutive sensing symbols and (2) a second type of transition occurring during the slot, from a transmission of one or more consecutive sensing symbols to a transmission of one or more consecutive communication symbols.

Clause 15: The method of any one of clauses 12-14 wherein one or more guard periods are defined to separate the transmission of the one or more consecutive communication symbols and the transmission of the one or more consecutive sensing symbols, each of the one or more guard periods spanning a duration of one or more communication symbols.

Clause 16: The method of clause 15 wherein a first guard period of the one or more guard periods is associated with the first type of transition and is positioned to separate the transmission of the one or more consecutive communication symbols and the transmission of the one or more consecutive sensing symbols, and a second guard period of the one or more guard periods is associated with the second type of transition and is positioned to separate the transmission of the one or more consecutive sensing symbols and the transmission of the one or more consecutive communication symbols.

Clause 17: The method of clause 16 wherein the communication device supports a plurality of slot configuration types, including: a first slot configuration type, corresponding to a transmission of one or more consecutive sensing symbols occupying an entire duration of the slot, a second slot configuration type, corresponding to an instance of the first guard period, followed by a transmission of one or more consecutive sensing symbols, a third slot configuration type, corresponding to an instance of the first guard period, followed by a transmission of one or more consecutive sensing symbols, followed by an instance of the second guard period, a fourth slot configuration type, corresponding to a transmission of one or more consecutive communication symbols, followed by an instance of the first guard period, followed by a transmission of one or more consecutive sensing symbols, a fifth slot configuration type, corresponding to a transmission of one or more consecutive communication symbols, followed by an instance of the first guard period, followed by a transmission of one or more consecutive sensing symbols, followed by an instance of the second guard period, a sixth slot configuration type, corresponding to a transmission of one or more consecutive sensing symbols, followed by an instance of the second guard period, followed by a transmission of one or more consecutive communication symbols, a seventh slot configuration type, corresponding to an instance of the first guard period, followed by a transmission of one or more consecutive sensing symbols, followed by an instance of the second guard period, followed by a transmission of one or more consecutive communication symbols, and an eighth slot configuration type, corresponding to a transmission of one or more consecutive communication symbols, followed by an instance of the first guard period, followed by a transmission of one or more consecutive sensing symbols, followed by an instance of the second guard period, followed by a transmission of one or more consecutive communication symbols.

Clause 18: The method of any one of clauses 16-17 wherein a third guard period separates a first sensing waveform from a second sensing waveforms in the one or more sensing waveforms, wherein a frequency jump is associated with an ending frequency of the first sensing waveform and a starting frequency of the second sensing waveform.

Clause 19: The method of any one of clauses 12-14 wherein one or more guard periods are defined to separate the transmissions of the one or more consecutive communication symbols and the one or more consecutive sensing symbols, each of the one or more guard periods having a duration less than a communication symbol.

Clause 20: The method of clause 19 wherein the communication device supports a plurality of slot configuration types, including: a first slot configuration type, corresponding to a transmission of one or more consecutive sensing symbols occupying an entire duration of the slot, a second configuration type, corresponding to a transmission of one or more consecutive communication symbols, followed by a transmission of one or more consecutive sensing symbols, a third slot configuration type, corresponding to a transmission of one or more consecutive sensing symbols, followed by a transmission of one or more consecutive communication symbols, and a fourth slot configuration type, corresponding to a transmission of one or more consecutive communication symbols, followed by a transmission of one or more consecutive sensing symbols, followed by a transmission of one or more consecutive communication symbols.

Clause 21: The method of any one of clauses 19-20 wherein each of the one or more guard periods is defined as part of a sensing symbol.

Clause 22: The method of any one of clauses 1-4 wherein the sensing waveform symbol duration is greater than the communication symbol duration.

Clause 23: The method of clause 22 wherein the sensing waveform symbol duration is equal to a times the communication symbol duration, receiving the one or communication signals and the one or more sensing signals comprises receiving M0 consecutive communication symbols and MF consecutive sensing symbols over L consecutive slots, and a and L are a positive integers equal to or greater than 1, and M0 and MF are positive integers equal to or greater than 0.

Clause 24: The method of clause 23 wherein a transmission of the M0 consecutive communication symbols and a transmission of the MF consecutive sensing symbols are separated by one or more guard periods, each of the guard periods having a duration equal to β times the communication symbol duration, and β is a positive integer equal to or greater than 1.

Clause 25: The method of clause 24 wherein the communication device supports a plurality of slot configuration types, including: a first slot configuration type, corresponding to a transmission of one or more consecutive sensing symbols occupying an entire duration of a slot, a second slot configuration type, corresponding to an instance of the one or more guard periods, followed by a transmission of one or more consecutive sensing symbols, a third slot configuration type, corresponding to a transmission of one or more consecutive sensing symbols, followed by an instance of the one or more guard periods, a fourth slot configuration type, corresponding to a first instance of the one or more guard periods, followed by a transmission of one or more consecutive sensing symbols, followed by a second instance of the one or more guard periods, a fifth slot configuration type, corresponding to a transmission of one or more consecutive communication symbols, followed by a first instance of the one or more guard periods, followed by a transmission of one or more consecutive sensing symbols, a sixth slot configuration type, corresponding to a transmission of one or more consecutive communication symbols, followed by a first instance of the one or more guard periods, followed by a transmission of one or more consecutive sensing symbols, followed by a second instance of the one or more guard periods, a seventh slot configuration type, corresponding to a transmission of one or more consecutive sensing symbols, followed by an instance of the one or more guard periods, followed by a transmission of one or more consecutive communication symbols, an eighth slot configuration type, corresponding to a first instance of the one or more guard periods, followed by a transmission of one or more consecutive sensing symbols, followed by a second instance of the one or more guard periods, followed by a transmission of one or more consecutive communication symbols, and a ninth slot configuration type, corresponding to a transmission of one or more consecutive communication symbols, followed by a first instance of the one or more guard periods, followed by a transmission of one or more consecutive sensing symbols, followed by a second instance of the one or more guard periods, followed by a transmission of one or more consecutive communication symbols.

Clause 26: The method of clause 23 wherein one or more guard periods is defined as part of each of the MF consecutive sensing symbols.

Clause 27: The method of clause 26 wherein the communication device supports a plurality of slot configuration types, including: a first slot configuration type, corresponding to a transmission of one or more consecutive sensing symbols occupying an entire duration of a slot, a second slot configuration type, corresponding to a transmission of one or more consecutive communication symbols, followed by a transmission of one or more consecutive sensing symbols, a third slot configuration type, corresponding to a transmission of one or more consecutive sensing symbols, followed by a transmission of one or more consecutive communication symbols, and a fourth slot configuration type, corresponding to a transmission of one or more consecutive communication symbols, followed by a transmission of one or more consecutive sensing symbols, followed by a transmission of one or more consecutive communication symbols.

Clause 28: A method of transmitting signals for communication and sensing comprising: transmitting, from a communication device, one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure; and transmitting, from the communication device, one or more communication signals within the air interface frame structure, wherein the one or more communication signals occupy a second subset of symbols in the plurality of symbols of the air interface frame structure, wherein the one or more sensing signals comprise one or more sensing waveforms, each of the one or more sensing waveforms being associated with a sensing waveform symbol duration, the sensing waveform symbol duration being aligned with one or more symbol boundaries of the air interface frame structure, wherein the one or more communication signals comprise one or more communication symbols, each of the one or more communication symbols being associated with a communication symbol duration, the communication symbol duration being aligned with one or more symbol boundaries of the air interface frame structure, and wherein the sensing waveform symbol duration is greater than or equal to the communication symbol duration.

Clause 29: A method of operating a communication device for communication and sensing comprising: receiving, at the communication device, one or more configuration parameters specifying one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein (1) the one or more sensing signals occupy a first subset symbols in the plurality of symbols of the air interface frame structure and (2) one or more communication signals occupy a second subset of symbols in the plurality of symbols of the air interface frame structure; and transmitting or receiving the one or more sensing signals in accordance with the one or more configuration parameters, wherein the one or more sensing signals comprise one or more sensing waveforms, each of the one or more sensing waveforms being associated with a sensing waveform symbol duration, the sensing waveform symbol duration being aligned with one or more symbol boundaries of the air interface frame structure, wherein the one or more communication signals comprise one or more communication symbols, each of the one or more communication symbols being associated with a communication symbol duration, the communication symbol duration being aligned with one or more symbol boundaries of the air interface frame structure, and wherein the sensing waveform symbol duration is greater than or equal to the communication symbol duration.

Clause 30: A device for receiving signals for communication and sensing comprising: one or more antennas; an analog-to-digital (A/D) converter coupled to the one or more antennas; one or more processors coupled to the A/D converter; and a memory coupled to the one or more processors, wherein: the one or more antennas are configured to receive a radio frequency (RF) signal, the RF signal comprising (1) one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure, and (2) one or more communication signals within the air interface frame structure, wherein the one or more communication signals occupy a second subset of symbols in the plurality of symbols of the air interface frame structure, wherein: the one or more sensing signals comprise one or more sensing waveforms, each of the one or more sensing waveforms being associated with a sensing waveform symbol duration, the sensing waveform symbol duration being aligned with one or more symbol boundaries of the air interface frame structure, the one or more communication signals comprise one or more communication symbols, each of the one or more communication symbols being associated with a communication symbol duration, the communication symbol duration being aligned with one or more symbol boundaries of the air interface frame structure, the sensing waveform symbol duration is greater than or equal to the communication symbol duration, the A/D converter is configured to generate a digital signal based on the RF signal, and the one or more processors are configured receive the digital signal to process the one or more sensing signals and the one or more communication signals.

What is claimed is:

1. A method of receiving signals for communication and sensing comprising:
receiving, at a communication device, one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure; and
receiving, at the communication device, one or more communication signals within the air interface frame structure, wherein the one or more communication signals occupy a second subset of symbols in the plurality of symbols of the air interface frame structure,
wherein the one or more sensing signals comprise one or more sensing waveforms, each of the one or more sensing waveforms being associated with a sensing waveform symbol duration, the sensing waveform symbol duration being aligned with one or more symbol boundaries of the air interface frame structure,
wherein the one or more communication signals comprise one or more communication symbols, each of the one or more communication symbols being associated with a communication symbol duration, the communication symbol duration being aligned with one or more symbol boundaries of the air interface frame structure, and
wherein the sensing waveform symbol duration is greater than or equal to the communication symbol duration.

2. The method of claim 1, wherein the one or more sensing signals comprise one or more frequency modulated continuous wave (FMCW) signals.

3. The method of claim 1, wherein the one or more communication signals comprise one or more orthogonal frequency-division multiplexing (OFDM) signals.

4. The method of claim 1,
wherein the one or more sensing signals occupy one or more sensing signal bandwidths,
wherein the one or more communication signals occupy one or more communication signal bandwidths,
wherein the one or more sensing signal bandwidths at least partially overlap the one or more communication signal bandwidths, and
wherein the one or more sensing signal bandwidths and the one or more communication signal bandwidths are separately configurable.

5. The method of claim 1, wherein the sensing waveform symbol duration is equal to the communication symbol duration.

6. The method of claim 5, wherein each of the one or more sensing signals spans one or more sensing slots comprising a first subset of the plurality of slots of the air interface frame structure, and wherein each of the one or more communication signals spans one or more communication slots comprising a second subset of the plurality of slots of the air interface frame structure.

7. The method of claim 6, wherein the one or more sensing slots and the one or more communication slots are defined based on a periodic schedule within the air interface frame structure.

8. The method of claim 7, wherein the periodic schedule is defined using at least (1) a sensing offset parameter, (2) a sensing period parameter, and (3) a sensing duration parameter.

9. The method of claim 7, wherein the periodic schedule is defined using at least (1) a sensing offset parameter, (2) a sensing period parameter, (3) a sensing duration parameter, (4) a number of repetitions parameter, (5) a gap between repetitions parameter, and (6) a sensing repetition offset parameter.

10. The method of claim 6, wherein the one or more sensing slots and the one or more communication slots are defined based on an aperiodic schedule within the air interface frame structure.

11. The method of claim 6, wherein the one or more sensing slots are configurable between (1) an activated state in which the one or more sensing slots are used for sensing signals and (2) a deactivated state in which the one or more sensing slots are used for communication signals.

12. The method of claim 5, wherein the communication device supports receiving one or more consecutive communication symbols and receiving one or more consecutive sensing symbols during a slot of the plurality of slots.

13. The method of claim 12, further comprising:
receiving, at the communication device, a first slot configuration parameter specifying a number of consecutive sensing symbols and a second slot configuration parameter specifying a starting sensing symbol.

14. The method of claim 12, wherein the communication device supports (1) a first type of transition occurring during the slot, from a transmission of one or more consecutive communication symbols to a transmission of one or more consecutive sensing symbols and (2) a second type of transition occurring during the slot, from a transmission of one or more consecutive sensing symbols to a transmission of one or more consecutive communication symbols.

15. The method of claim 14, wherein one or more guard periods are defined to separate the transmission of the one or more consecutive communication symbols and the transmission of the one or more consecutive sensing symbols, each of the one or more guard periods spanning a duration of one or more communication symbols.

16. The method of claim 15, wherein:
a first guard period of the one or more guard periods is associated with the first type of transition and is positioned to separate the transmission of the one or more consecutive communication symbols and the transmission of the one or more consecutive sensing symbols, and
a second guard period of the one or more guard periods is associated with the second type of transition and is positioned to separatee the transmission of the one or more consecutive sensing symbols and the transmission of the one or more consecutive communication symbols.

17. The method of claim 16, wherein the communication device supports a plurality of slot configuration types, including:
a first slot configuration type, corresponding to a transmission of one or more consecutive sensing symbols occupying an entire duration of the slot,
a second slot configuration type, corresponding to an instance of the first guard period, followed by a transmission of one or more consecutive sensing symbols,
a third slot configuration type, corresponding to an instance of the first guard period, followed by a transmission of one or more consecutive sensing symbols, followed by an instance of the second guard period,
a fourth slot configuration type, corresponding to a transmission of one or more consecutive communication symbols, followed by an instance of the first guard period, followed by a transmission of one or more consecutive sensing symbols,
a fifth slot configuration type, corresponding to a transmission of one or more consecutive communication symbols, followed by an instance of the first guard period, followed by a transmission of one or more consecutive sensing symbols, followed by an instance of the second guard period,
a sixth slot configuration type, corresponding to a transmission of one or more consecutive sensing symbols, followed by an instance of the second guard period, followed by a transmission of one or more consecutive communication symbols,
a seventh slot configuration type, corresponding to an instance of the first guard period, followed by a transmission of one or more consecutive sensing symbols, followed by an instance of the second guard period, followed by a transmission of one or more consecutive communication symbols, and
an eighth slot configuration type, corresponding to a transmission of one or more consecutive communication symbols, followed by an instance of the first guard period, followed by a transmission of one or more consecutive sensing symbols, followed by an instance of the second guard period, followed by a transmission of one or more consecutive communication symbols.

18. The method of claim 16, wherein a third guard period separates a first sensing waveform from a second sensing waveforms in the one or more sensing waveforms, wherein a frequency jump is associated with an ending frequency of the first sensing waveform and a starting frequency of the second sensing waveform.

19. The method of claim 14, wherein one or more guard periods are defined to separate the transmissions of the one or more consecutive communication symbols and the one or more consecutive sensing symbols, each of the one or more guard periods having a duration less than a communication symbol.

20. The method of claim 19, wherein the communication device supports a plurality of slot configuration types, including:
a first slot configuration type, corresponding to a transmission of one or more consecutive sensing symbols occupying an entire duration of the slot,
a second configuration type, corresponding to a transmission of one or more consecutive communication symbols, followed by a transmission of one or more consecutive sensing symbols,
a third slot configuration type, corresponding to a transmission of one or more consecutive sensing symbols, followed by a transmission of one or more consecutive communication symbols, and
a fourth slot configuration type, corresponding to a transmission of one or more consecutive communication symbols, followed by a transmission of one or more consecutive sensing symbols, followed by a transmission of one or more consecutive communication symbols.

21. The method of claim 20, wherein each of the one or more guard periods is defined as part of a sensing symbol.

22. The method of claim 1, wherein the sensing waveform symbol duration is greater than the communication symbol duration.

23. The method of claim 22, wherein:
the sensing waveform symbol duration is equal to a times the communication symbol duration,
receiving the one or communication signals and the one or more sensing signals comprises receiving M₀ consecutive communication symbols and M_{F} consecutive sensing symbols over L consecutive slots, and
α and L are a positive integers equal to or greater than 1, and M₀ and M_{F} are positive integers equal to or greater than 0.

24. The method of claim 23, wherein a transmission of the M₀ consecutive communication symbols and a transmission of the M_{F} consecutive sensing symbols are separated by one or more guard periods, each of the guard periods having a duration equal to β times the communication symbol duration, and β is a positive integer equal to or greater than 1.

25. The method of claim 24, wherein the communication device supports a plurality of slot configuration types, including:
a first slot configuration type, corresponding to a transmission of one or more consecutive sensing symbols occupying an entire duration of a slot,
a second slot configuration type, corresponding to an instance of the one or more guard periods, followed by a transmission of one or more consecutive sensing symbols,
a third slot configuration type, corresponding to a transmission of one or more consecutive sensing symbols, followed by an instance of the one or more guard periods,
a fourth slot configuration type, corresponding to a first instance of the one or more guard periods, followed by a transmission of one or more consecutive sensing symbols, followed by a second instance of the one or more guard periods,
a fifth slot configuration type, corresponding to a transmission of one or more consecutive communication symbols, followed by a first instance of the one or more guard periods, followed by a transmission of one or more consecutive sensing symbols,
a sixth slot configuration type, corresponding to a transmission of one or more consecutive communication symbols, followed by a first instance of the one or more guard periods, followed by a transmission of one or more consecutive sensing symbols, followed by a second instance of the one or more guard periods,
a seventh slot configuration type, corresponding to a transmission of one or more consecutive sensing symbols, followed by an instance of the one or more guard periods, followed by a transmission of one or more consecutive communication symbols,
an eighth slot configuration type, corresponding to a first instance of the one or more guard periods, followed by a transmission of one or more consecutive sensing symbols, followed by a second instance of the one or more guard periods, followed by a transmission of one or more consecutive communication symbols, and
a ninth slot configuration type, corresponding to a transmission of one or more consecutive communication symbols, followed by a first instance of the one or more guard periods, followed by a transmission of one or more consecutive sensing symbols, followed by a second instance of the one or more guard periods, followed by a transmission of one or more consecutive communication symbols.

26. The method of claim 23, wherein one or more guard periods is defined as part of each of the M_{F} consecutive sensing symbols.

27. The method of claim 26, wherein the communication device supports a plurality of slot configuration types, including:
a first slot configuration type, corresponding to a transmission of one or more consecutive sensing symbols occupying an entire duration of a slot,
a second slot configuration type, corresponding to a transmission of one or more consecutive communication symbols, followed by a transmission of one or more consecutive sensing symbols,
a third slot configuration type, corresponding to a transmission of one or more consecutive sensing symbols, followed by a transmission of one or more consecutive communication symbols, and
a fourth slot configuration type, corresponding to a transmission of one or more consecutive communication symbols, followed by a transmission of one or more consecutive sensing symbols, followed by a transmission of one or more consecutive communication symbols.

28. A method of transmitting signals for communication and sensing comprising:
transmitting, from a communication device, one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure; and
transmitting, from the communication device, one or more communication signals within the air interface frame structure, wherein the one or more communication signals occupy a second subset of symbols in the plurality of symbols of the air interface frame structure,
wherein the one or more sensing signals comprise one or more sensing waveforms, each of the one or more sensing waveforms being associated with a sensing waveform symbol duration, the sensing waveform symbol duration being aligned with one or more symbol boundaries of the air interface frame structure,
wherein the one or more communication signals comprise one or more communication symbols, each of the one or more communication symbols being associated with a communication symbol duration, the communication symbol duration being aligned with one or more symbol boundaries of the air interface frame structure, and
wherein the sensing waveform symbol duration is greater than or equal to the communication symbol duration.

29. A method of operating a communication device for communication and sensing comprising:
receiving, at the communication device, one or more configuration parameters specifying one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein (1) the one or more sensing signals occupy a first subset symbols in the plurality of symbols of the air interface frame structure and (2) one or more communication signals occupy a second subset of symbols in the plurality of symbols of the air interface frame structure; and
transmitting or receiving the one or more sensing signals in accordance with the one or more configuration parameters,
wherein the one or more sensing signals comprise one or more sensing waveforms, each of the one or more sensing waveforms being associated with a sensing waveform symbol duration, the sensing waveform symbol duration being aligned with one or more symbol boundaries of the air interface frame structure,
wherein the one or more communication signals comprise one or more communication symbols, each of the one or more communication symbols being associated with a communication symbol duration, the communication symbol duration being aligned with one or more symbol boundaries of the air interface frame structure, and
wherein the sensing waveform symbol duration is greater than or equal to the communication symbol duration.

30. A device for receiving signals for communication and sensing comprising:
one or more antennas;
an analog-to-digital (A/D) converter coupled to the one or more antennas;
one or more processors coupled to the A/D converter; and
a memory coupled to the one or more processors, wherein:
the one or more antennas are configured to receive a radio frequency (RF) signal, the RF signal comprising (1) one or more sensing signals within an air interface frame structure, the air interface frame structure comprising a plurality of slots, each slot comprising a plurality of symbols in a time domain, the air interface frame structure further comprising a plurality of carriers, each carrier comprising a plurality of subcarriers in a frequency domain, wherein the one or more sensing signals occupy a first subset symbols in the plurality of symbols of the air interface frame structure, and (2) one or more communication signals within the air interface frame structure, wherein the one or more communication signals occupy a second subset of symbols in the plurality of symbols of the air interface frame structure, wherein:
the one or more sensing signals comprise one or more sensing waveforms, each of the one or more sensing waveforms being associated with a sensing waveform symbol duration, the sensing waveform symbol duration being aligned with one or more symbol boundaries of the air interface frame structure,
the one or more communication signals comprise one or more communication symbols, each of the one or more communication symbols being associated with a communication symbol duration, the communication symbol duration being aligned with one or more symbol boundaries of the air interface frame structure,
the sensing waveform symbol duration is greater than or equal to the communication symbol duration,
the A/D converter is configured to generate a digital signal based on the RF signal, and
the one or more processors are configured receive the digital signal to process the one or more sensing signals and the one or more communication signals.
